(19) United States
(12) Patent Application Publication
(10) Pub. No.: US 2025/0348021 A1
(43) Pub. Date: Nov. 13, 2025

(54) IMAGE FORMING APPARATUS

(71) Applicant: CANON KABUSHIKI KAISHA, Tokyo (JP)

(72) Inventors: Hideo Kihara, Kanagawa (JP); Jun Hara, Kanagawa (JP); Tsubasa Yoshida, Chiba (JP)

(21) Appl. No.: 19/176,326

(22) Filed: Apr. 11, 2025

(30) Foreign Application Priority Data
May 12, 2024 (JP) 2024-077636

(51) Int. Cl. G03G 15/06; G03G 15/08

(52) U.S. Cl. CPC G03G 15/065; G03G 15/0856; G03G 15/0875

(57) ABSTRACT

An image forming apparatus includes an image bearing member, a developing unit including a developing member and a supplying member, a developing voltage applying portion, a supplying voltage applying portion and a control portion. During non-image formation in a state in which the developing member and the supplying member rotate, the control portion is capable of controlling the developing voltage applying portion and the supplying voltage applying portion so as to perform a preliminary operation in which a first potential difference and a second potential difference different from the first potential difference are formed between the developing member and the supplying member by being alternately switched for a plurality of number of times based on toner amount information regarding a toner amount in the developing unit.

### FIELD OF THE INVENTION AND RELATED ART

The present invention relates to an image forming apparatus such as a printer, a copy machine and a facsimile machine using an electrophotographic type or an electrostatic recording type.

The image forming apparatus such as the printer using the electrophotographic type (electrophotographic process) includes a developing device which develops an electrostatic latent image formed on an image bearing member such as a photosensitive drum using toner as developer. There is a case in which the developing device is configured, either alone as an independent unit or as a part of a process cartridge, to be mountable to and dismountable from a main assembly of the image forming apparatus.

As such developing devices, there is a developing device which includes a developing roller as a developing member, which supplies the toner to the image bearing member, and a supplying roller as a supplying member (supplying and peeling-off member), which performs supply of the toner to the developing roller and peeling off of the toner from the developing roller. In addition, there is a case in which, between the developing roller and the supplying roller, a potential difference is provided.

In Japanese Patent Application Laid-Open No. 2001-109242, it is described that while developing an electrostatic latent image, a voltage on a side with which the toner is supplied from the supplying roller to the developing roller is applied to the supplying roller, and after the development and until stop of rotation of the developing roller, a voltage on a side with which the toner is peeled off from the developing roller is applied to the supplying roller.

In addition, in Japanese Patent Application Laid-Open No. 2009-237549, it is described that in a case in which printing image information longer than a peripheral length of the developing roller is detected, a potential applied to the supplying roller is increased to a side with which the toner is supplied to the developing roller.

In recent years, as a life of the developing device (or process cartridge) gets longer, there has been a need that a toner amount accommodated in the developing device is increased. And in a case in which enlargement of capacity of the developing device is realized as such, the following problem may occur.

That is, as the capacity of the developing device is enlarged, it becomes likely for the toner around the developing roller and the supplying roller to be in a compacted state. In such a state, circulation of the toner becomes poor, making it difficult for the toner to be discharged from the supplying roller. Because of this, the supplying roller cannot peel off the toner on the developing roller, and a large amount of the toner may remain on the developing roller. As a result, image defect may occur.

### SUMMARY OF THE INVENTION

Therefore, an object of the present invention is to suppress an occurrence of image defect due to peeling off of toner from a developing member with a supplying member becoming insufficient.

The above object is achieved with an image forming apparatus according to the present invention. In summary, according to the present invention, there is provided an image forming apparatus comprising: a rotatable image bearing member; a developing unit configured to develop an electrostatic latent image formed on a surface of the image bearing member with toner, the developing unit including a rotatable developing member configured to supply the toner to the electrostatic latent image and a rotatable supplying member in contact with the developing member and configured to supply the toner to the developing member; a developing voltage applying portion configured to apply a voltage to the developing member; a supplying voltage applying portion configured to apply a voltage to the supplying member; and a control portion configured to control the developing voltage applying portion and the supplying voltage applying portion, wherein during non-image formation in a state in which the developing member and the supplying member rotate, the control portion is capable of controlling the developing voltage applying portion and the supplying voltage applying portion so as to perform a preliminary operation in which a first potential difference and a second potential difference different from the first potential difference are formed between the developing member and the supplying member and alternately switched for a plurality of number of times based on toner amount information regarding a toner amount in the developing unit.

Further features of the present invention will become apparent from the following description of exemplary embodiments with reference to the attached drawings.

### BRIEF DESCRIPTION OF THE DRAWINGS

FIG. 1 is a cross-sectional outline view of an image forming apparatus.

FIG. 2 is an outline block diagram illustrating a control configuration of the image forming apparatus.

FIG. 3 is a cross-sectional outline view of a developing device.

FIG. 4 is a cross-sectional outline view illustrating a state of toner in the developing device.

FIG. 5, part (a), part (b) and part (c), includes timing chart diagrams illustrating relationship between a potential of a developing roller and a potential of a supplying roller during preliminary operation.

FIG. 6 is a schematic view illustrating a control configuration in an Embodiment 2.

FIG. 7 is a schematic view of a light guide member of a toner amount sensor.

FIG. 8 is a schematic view illustrating a circuit configuration of the toner amount sensor.

FIG. 9 is a flowchart diagram for describing a calculation method for deterioration degree of the toner.

FIG. 10 is a flowchart diagram for describing control of a preliminary operation in the Embodiment 2.

FIG. 11, part (a) and part (b), includes cross-sectional outline views of a process cartridge and a toner cartridge in an Embodiment 3.

FIG. 12 is a cross-sectional outline view illustrating a state of the toner in a developing device after exchange of the toner cartridge.

FIG. 13 is a flowchart diagram for describing control of a preliminary operation in an Embodiment 4.

### DESCRIPTION OF THE EMBODIMENTS

Hereinafter, an image forming apparatus according to the present invention will be described in more detail according to the drawings.

### <Overall Configuration and Operation of the Image Forming Apparatus>

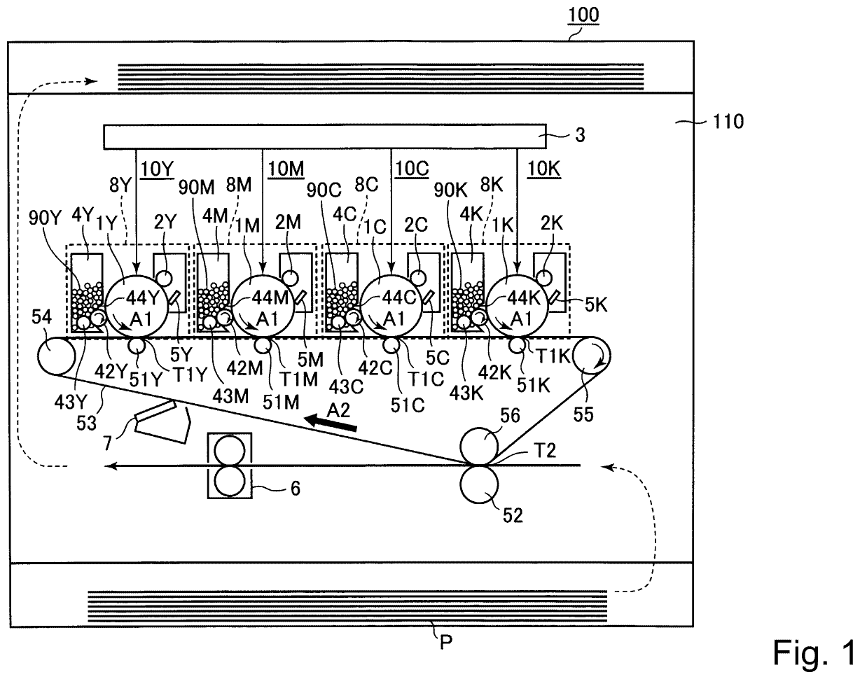

An overall configuration and operation of the image forming apparatus in the present Embodiment (Embodiment 1) will be described. FIG. 1 is a schematic cross-sectional view of an image forming apparatus 100 in the present Embodiment. The image forming apparatus 100 in the present Embodiment is a laser beam printer of a tandem type employing an intermediary transfer type, which is capable of forming a full-color image using an electrophotographic type.

The image forming apparatus 100 includes, as a plurality of image forming portions, four image forming portions 10Y, 10M, 10C and 10K which form an image of each color of yellow (Y), magenta (M), cyan (C) and black (K), respectively. These image forming portions 10Y, 10M, 10C and 10K are disposed in a row along a moving direction of an image transfer surface of an intermediary transfer belt 53, which will be described below. Incidentally, elements having the same or corresponding functions or configurations, which are provided for each color, may be described collectively by omitting Y, M, C and K at the ends of reference numerals indicating that the element is for either one of the colors. In addition, with respect to the image forming apparatus 100 and elements thereof, up and down refers to up and down in a direction of gravity (vertical direction), however, it does not mean directly above or directly below only, but includes an upside and a downside of a horizontal plane passing through a referenced position or element.

The image forming portion 10 is configured to include a photosensitive drum 1, a charging roller 2, an exposure device 3, a developing device 4, a cleaning device 5, etc. In the present Embodiment, the exposure device 3 is configured as a single unit which exposes the photosensitive drums 1 in each image forming portion 10. In this manner, in the present Embodiment, the exposure apparatus 3 is commonized to a plurality of the image forming portions 10, however, it may be provided for each image forming portion 10.

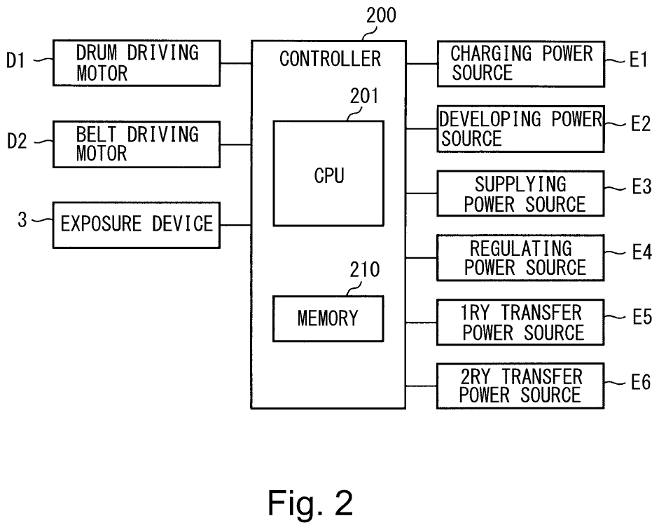

The photosensitive drum 1 is a rotatable photosensitive member (electrophotographic photosensitive member) having a drum shape (cylindrical shape), and is an example of an image bearing member. The photosensitive drum 1 is rotationally driven in a direction of an arrow A1 (counterclockwise direction) in FIG. 1 about an axis thereof by driving force transmitted from a drum driving motor D1 (FIG. 2), which is a driving source constituting a driving portion (driving device) as a driving means. In the present Embodiment, the photosensitive drum 1 is rotationally driven, for example, at a rotation speed in which a peripheral speed, which is a moving speed of a surface (outer peripheral surface) thereof, is 140 mm/s.

The surface of the rotating photosensitive drum 1 is uniformly charged to a predetermined potential of a predetermined polarity (negative polarity in the present Embodiment) by the charging roller 2, which is a charging member having a roller shape as a charging means. In the present Embodiment, the charging roller 2 is a conductive roller, in which a conductive rubber layer is provided on a core metal thereof. The charging roller 2 is disposed so as to contact the surface of the photosensitive drum 1 with a predetermined pressure, and is rotationally driven following the rotation of the photosensitive drum 1. During charging process, to the charging roller 2, a predetermined charging voltage (charging bias) is applied by a charging power source E1 (FIG. 2) as a charging voltage applying portion. In the present Embodiment, to the charging roller 2, as the charging voltage, for example, a direct current voltage of −1250 V is applied, and the surface of the photosensitive drum 1 is uniformly charged to a surface potential (charged potential, dark portion potential) of about −600 V.

The charged surface of the photosensitive drum 1 is scanned and exposed by the exposure device (exposure unit) 3 as an exposure means, and an electrostatic latent image (electrostatic image) is formed on the photosensitive drum 1. In the present Embodiment, the exposure device 3 is constituted by a laser scanner, and irradiates while scanning the surface of the photosensitive drum 1 with a laser light corresponding to an image signal. As a result, the electrostatic latent image corresponding to the image signal is formed on the charged surface of the photosensitive drum 1. The image signal is input to the image forming apparatus 100 from an external device (not shown) in response to a request from a user. The external device is, for example, an image reading apparatus (not shown), which is connected to a main assembly of the image forming apparatus 100 (hereinafter, simply referred to as an “apparatus main assembly” as well), a host device such as a personal computer, which is communicably connected to the apparatus main assembly 110 (not shown), etc.

The electrostatic latent image formed on the photosensitive drum 1 is developed (visualized) by toner as developer being supplied by the developing device 4 as a developing means, and a toner image (toner figure, developer image) is formed on the photosensitive drum 1. The developing device 4 forms the toner image by adhering the toner, which is charged to the same polarity as the charging polarity of the photosensitive drum 1, to a portion of the surface of the photosensitive drum 1, in which an electric charge has been attenuated by the exposure (image portion, exposed portion) (reverse developing type). In the present Embodiment, the developing device 4 uses toner 90, as the developer, which is a non-magnetic one-component developer. In the present Embodiment, of this toner 90, a normal charging polarity (normal polarity), which is a primary charging polarity during development is negative polarity. The developing device 4 includes a developing roller 42, a supplying roller 43, a regulating blade (developing blade) 44, etc. The developing roller 42 forms a developing portion by contacting the photosensitive drum 1, and supplies the toner, which is charged to the normal polarity, to the photosensitive drum 1 in the developing portion. Details on the developing device 4 will be described below.

The intermediary transfer belt 53, which is constituted by an endless belt, as an intermediary transfer member is disposed so as to oppose the four photosensitive drums 1Y, 1M, 1C and 1K. The intermediary transfer belt 53 is stretched over a tension roller 54, a driving roller 55 and a secondary transfer opposite roller 56 as a plurality of tension rollers. The tension roller 54 applies a predetermined tensile force (tension) to the intermediary transfer belt 53. The driving roller 55 is rotationally driven by driving force transmitted from a belt driving motor D2 (FIG. 2), which is a driving source constituting the driving portion as the driving means. The intermediary transfer belt 53 is rotated (peripherally moved) by the driving force being transmitted from the driving roller 55, in a direction of an arrow A2 in FIG. 1 (clockwise direction) at a peripheral speed, which is approximately the same as the peripheral speed of the photosensitive drum 1. The secondary transfer opposite roller 56 functions as an opposing member (opposite roller) of a secondary transfer roller 52, which will be described below. On an inner peripheral surface side of the intermediary transfer belt 53, corresponding to each photosensitive drum 1, primary transfer rollers 51Y, 51M, 51C and 51K, which are primary transfer members having a roller shape as primary transfer means, are disposed, respectively. The primary transfer roller 51 presses the intermediary transfer belt 53 toward the photosensitive drum 1 to form a primary transfer portion (primary transfer nip) T1, which is a contacting portion between the photosensitive drum 1 and the intermediary transfer belt 53. The stretching rollers, other than the driving roller 55, and each primary transfer roller 51 are rotated following the rotation of the intermediary transfer belt 53.

The toner image formed on the photosensitive drum 1 is, in the primary transfer portion T1, by an action of the primary transfer roller 51, electrostatically transferred (primary transfer) onto the intermediary transfer belt 53 as a rotating transferred member. During the primary transfer, to the primary transfer roller 51, by a primary transfer power source E5 (FIG. 2) as a primary transfer voltage applying portion, a primary transfer voltage (primary transfer bias) of a reverse polarity to the normal polarity of the toner (positive polarity in the present Embodiment) is applied. For example, during formation of a full-color image, the toner images of each color of yellow, magenta, cyan and black, which are formed on each photosensitive drum 1Y, 1M, 1C and 1K, are sequentially superimposed and transferred onto the intermediary transfer belt 53.

On an outer peripheral surface side of the intermediary transfer belt 53, at a position opposite to the secondary transfer opposite roller 56, the secondary transfer roller 52, which is a secondary transfer member having a roller shape, as a secondary transfer means is disposed. The secondary transfer roller 52 is pressed toward the secondary transfer opposite roller 56 via the intermediary transfer belt 53, and forms a secondary transfer portion (secondary transfer nip) T2, which is a contacting portion between the intermediary transfer belt 53 and the secondary transfer roller 52. The secondary transfer roller 52 is rotated following the rotation of the intermediary transfer belt 53. Incidentally, the secondary transfer roller 52 may be configured to be rotationally driven by driving force from a driving source. The toner image formed on the intermediary transfer belt 53 is, in the secondary transfer portion T2, by an action of the secondary transfer roller 52, electrostatically transferred (secondary transfer) onto a recording material P as a transferred member, which is being nipped and conveyed between the intermediary transfer belt 53 and the secondary transfer roller 52. During the secondary transfer, to the secondary transfer roller 52, by a secondary transfer power source E6 (FIG. 2) as a secondary transfer voltage applying portion, a secondary transfer voltage (secondary transfer bias) of the reverse polarity to the normal polarity of the toner (positive polarity in the present Embodiment) is applied. The secondary transfer opposite roller 56 is electrically grounded (connected to ground). Incidentally, it may be configured as the secondary transfer voltage of the same polarity as the normal polarity of the toner is applied to a secondary transfer inner roller, which corresponds to the secondary transfer opposite roller 56 in the present Embodiment, and a secondary transfer outer roller, which corresponds to the secondary transfer roller 52 in the present Embodiment, is electrically grounded. The recording material (transfer material, recording medium, sheet) P having a sheet shape such as a paper and a plastic sheet is conveyed by a feeding device (not shown), which is provided with a recording material accommodating portion, a sheet feeding member, a conveying member, etc., to the secondary transfer portion T2 at a predetermined timing.

The recording material P onto which the toner image has been transferred is conveyed to a fixing device 6 as a fixing means. The fixing device 6 fixes (melts, solidly fixes), by heating and pressing the recording material P carrying the unfixed toner image, the toner image onto the recording material P. The recording material P onto which the toner image has been fixed is discharged (output) to an outside of the apparatus main assembly 110 as an image formed product.

On the other hand, the toner remaining on the surface of photosensitive drum 1 after the primary transfer (primary transfer residual toner) is, by the cleaning device 5 as a photosensitive member cleaning means, removed from the surface of photosensitive drum 1 and collected. The cleaning device 5 scrapes and collects, with a cleaning blade as a cleaning member which is provided so as to be in contact with the surface of the photosensitive drum 1, the primary transfer residual toner from the surface of the rotating photosensitive drum 1. However, it may be configured as the image forming apparatus 100 does not include a dedicated cleaning device for cleaning the surface of the photosensitive drum 1, but collect the primary transfer residual toner from the surface of the photosensitive drum 1 with the developing device 4 (cleanerless type). In addition, on the outer peripheral surface side of the intermediary transfer belt 53, a belt cleaning device 7 as an intermediary transfer member cleaning means is disposed. The belt cleaning device 7 is disposed on a downstream side of the secondary transfer portion T2 and on an upstream side of the primary transfer portion T1 (a most upstream primary transfer portion T1Y) in the moving direction of the surface of the intermediary transfer belt 53. Adherent material such as the toner remaining on the surface of the intermediary transfer belt 53 after the secondary transfer (secondary transfer residual toner) is removed from the surface of the intermediary transfer belt 53 and collected by the belt cleaning device 7.

In the present Embodiment, in each image forming portion 10, the photosensitive drum 1 and the charging roller 2, the developing device 4 and the cleaning device 5 as process means acting thereon are integrated as a process cartridge 8. The process cartridge 8 is configured to be mountable to and dismountable from the apparatus main assembly 110. However, it is not limited thereto but, for example, it may be configured as the developing device 4 is mountable to and dismountable from the apparatus main assembly 110 substantially independently. Incidentally, in the present Embodiment, the apparatus main assembly 110 of the image forming apparatus 100 is a part which is the image forming apparatus 100 minus each process cartridge 8.

FIG. 2 is an outline block diagram illustrating a control configuration of the image forming apparatus 100 in the present Embodiment. The image forming apparatus 100 includes a control portion 200 which collectively controls each portion of the image forming apparatus 100. The control portion 200 includes a CPU 201 as a calculation processing means, which is a central element performing calculation processes. In addition, the control portion 200 includes a main assembly storage portion 210 constituted by a ROM, a RAM, a nonvolatile memory, etc., as a storage means (storage portion) which stores information. In the ROM, control programs, data tables obtained in advance, etc. are stored, and in the RAM, information input to the control portion 200, detected information, calculation results, etc. are stored, and in the nonvolatile memory, various types of setting information, etc. are stored. The CPU 200 and the main assembly storage portion 210 are configured to be capable of transferring and reading of data to and from each other. In addition, the control portion 200 includes an input/output portion (not shown) for performing exchange of signals between the control portion 200 and each portion of the image forming apparatus 100.

To the control portion 200, various types of the driving portions such as the drum driving motor D1 and the belt driving motor D2, for example, are connected. In addition, to the control portion 200, various types of the power sources such as the charging power source E1, a developing power source E2, which will be described below, a supplying power source E3, which will be described below, a regulating power source E4, which will be described below, the primary transfer power source E5 and the secondary transfer power source E6 are connected. In addition, to the control portion 200, the exposure device 3 and various types of sensors are connected. In addition, to the control portion 200, optionally, the external device such as the image reading apparatus and the personal computer (not shown) are connected. The control portion 200 is capable of controlling, according to the image signal input from the external device, so as to perform the image formation, operation of each portion of the image forming apparatus 100. In addition, the control portion 200 is capable of controlling, so as to perform a preliminary operation, which will be described below, the developing power source E2, the supplying power source E3, etc.

Incidentally, though illustration in the figure is omitted, in the present Embodiment, the charging power source E1, the developing power source E2, the supplying power source E3, the regulating power source E4 and the primary transfer power source E5 are provided independently of each image forming portion 10, respectively. However, it may be configured as at least one of these power sources is commonized to the plurality of the image forming portions 10 (or even to all of the image forming portions 10). In addition, although illustration in the figure is omitted, in the present Embodiment, the drum driving motor D1 is provided independently of each image forming portion 10. However, the drum driving motor D1 may be commonized to the plurality of the image forming portions 10 (or even to all of the image forming portions 10). In addition, at least one of the drum driving motors D1 and the belt driving motor D2 may be commonized.

In addition, the image forming apparatus 100 performs a job (print job), which is started by a single start instruction and is a series of operations to form and output the image on a single or a plurality of the recording materials P. The job generally includes an image forming process, a pre-rotation process, a sheet interval process in a case in which the images are formed on a plurality of the recording materials P, and a post-rotation process. The image forming process is a period during which the formation of the electrostatic image of the image to be actually formed and output on the recording material P, the formation of the toner image, and the primary transfer and the secondary transfer of the toner image are performed, and during image formation (image forming period) refers to this period. In more detail, timings of the during image formation differ at positions at which each process of the formation of the electrostatic image, the formation of the toner image, and the primary transfer and the secondary transfer of the toner image is performed. The pre-rotation process is a period, which is from the start instruction being input and until actually starting to form the image and during which preparatory operation prior to the image forming process is performed. The sheet interval process is a period corresponding to an interval between the recording material P and the recording material P upon performing the image formation continuously to a plurality of the recording material P (continuous image formation). The post-rotation process is a period during which organizing operations (preparatory operations) after the image forming process are performed. During non-image formation (non-image forming period) is a period other than during image formation, and includes the pre-rotation process, the sheet interval process, the post-rotation process, and furthermore a pre-multi-rotation process, which is a preparatory operation when the image forming apparatus 100 is turned on or returns from a sleep state.

### <Developing Device>

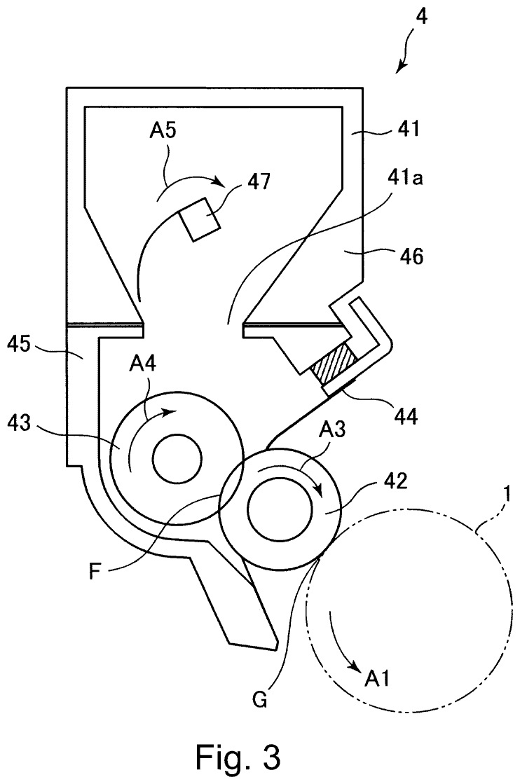

Next, the developing device 4 in the present Embodiment will be described. FIG. 3 is a cross-sectional outline view of the developing device 4 in the present Embodiment.

An outline configuration of the developing device 4 will be described. The developing device 4 includes a developing container (developing frame member) 41, a rotatable developing roller 42 as a developing member (developer carrying member), and a rotatable supplying roller 43 as a supplying member (supplying and peeling-off member). In addition, the developing device 4 includes the regulating blade 44 as a regulating member and a rotatable stirring member 47. The developing container 41 accommodates the toner 90 as the developer. The developing roller 42 is provided so as to be rotatable and so that a part thereof is exposed to an outside through a developing opening portion, which is an opening portion provided in the developing container 41 and opposite to the photosensitive drum 1, and by being rotated while carrying the toner, conveys the toner from an inside to the outside of the developing container 41. The supplying roller 43 contacts the developing roller 42 and forms a supplying and peeling-off portion F. The supplying roller 43, by being rotated, performs supply of the toner to the developing roller 42 and peeling off of the toner from the developing roller 42 in the supplying and peeling-off portion F. The regulating blade 44 is provided so as to be in contact with a surface of the developing roller 42 and regulates a toner amount, which is carried by the developing roller 42 and passes through the developing opening portion of the developing container 41. The stirring member 47 stirs and conveys the toner. The developing roller 42 contacts the photosensitive drum 1 and forms a developing portion G. The developing roller 42 supplies the toner, which is charged to the normal polarity, to the photosensitive drum 1 in the developing portion G. Hereinafter, it will be described in more detail.

The developing container 41 forms a developing chamber 45, which is provided with the developing roller 42, the supplying roller 43 and the regulating blade 44, and a toner accommodating chamber 46, which accommodates the toner 90 to be supplied to the developing chamber 45 and is provided with the stirring member 47. The developing chamber 45 and the toner accommodating chamber 46 are communicated with a supplying opening portion 41a, which is an opening portion. Through this supplying opening portion 41a, the toner 90 is supplied from the toner accommodating chamber 46 to the developing chamber 45. In the present Embodiment, the developing chamber 45 is disposed at a lower side in the direction of gravity with respect to the toner accommodating chamber 46. The supply of the toner 90 from an inside of the toner accommodating chamber 46 to the developing chamber 45 is performed using conveyance force of the stirring member 47 and also performed by utilizing gravity.

The toner 90 supplied to the developing chamber 45 is supplied, in the supplying and peeling-off portion F, which is a contacting portion between the supplying roller 43 and the developing roller 42, to the surface of the developing roller 42 by the supplying roller 43. And the toner 90 held on the developing roller 42 is regulated by the regulating blade 44 in thickness of a layer thereof (here, also referred to as a “layer thickness”) and made into a thin layer. Here, the regulating blade 44 has a function as a regulating means which regulates the layer thickness of the toner 90 on the developing roller 42, and also has a function as a developer charging means which applies a predetermined electric charge to the toner 90 on the developing roller 42. The thin-layered toner 90 is conveyed into the developing portion G, which is a contacting portion between the photosensitive drum 1 and the developing roller 42, following the rotation of the developing roller 42, and adhered to the surface of the photosensitive drum 1 according to the electrostatic latent image formed on the surface of the photosensitive drum 1. In addition, the toner 90 which is not supplied for the development and remains on the developing roller 42 is, in the supplying and peeling-off portion F, which is the contacting portion between the supplying roller 43 and the developing roller 42, peeled off by the supplying roller 43 and removed from the developing roller 42. The toner 90 removed from the developing roller 42 is stirred and mixed with the toner 90 in the developing device 4.

In the present Embodiment, a non-magnetic toner having negative chargeability produced by a suspension polymerization method is used. However, it is not limited thereto, but for example, the toner which is produced by using other polymerization methods such as a grinding method and an emulsion polymerization method may also be used. As for a volume-average particle diameter of the toner, it is preferable to be 5.0-8.0 μm. Incidentally, for a numerical range, “-” means that values before and after that symbol are included.

Here, the volume-average particle diameter of the toner is measured with a precision particle size distribution measuring device Multisizer 3 manufactured by Beckman Coulter Inc. In the present Embodiment, the volume-average particle diameter of the toner is about 7.0 μm.

In addition, in the present Embodiment, all of the four colors of the toners are toner particles containing a toner base particle, which contains a release agent, and an organic silicon polymer on a surface of the toner base particle. The organic silicon polymer has a T3 unit structure expressed as R—Si(O_{1/2})₃, where R represents an alkyl group, of which a carbon number is 1 or more and 6 or less, or a phenyl group, and the organic silicon polymer forms projecting portions on the surface of the toner base particle. By this, spacer effect is generated between the surface of the toner base particle and members such as the developing roller 42, and adhesion therebetween becomes smaller. In addition, the projecting portions are characterized to have surface-to-surface contact to the surface of the toner base particle, and by having the surface-to-surface contact, it can be expected that suppressing effect against moving, detaching and burying of the projecting portions becomes significant. Thus, even in a configuration in which the developing roller 42 is driven in a state separated from the photosensitive drum 1, it becomes possible to use the toner for a long period of time. As such, in the present Embodiment, the toner particle which contains the organic silicon polymer on the surface of the toner base particle is used. However, it is not limited thereto, but for example, a toner particle which does not contain the organic silicon polymer on the surface of the toner base particle may also be used.

In addition, to the toner, in order to improve flowability, chargeability, cleanability, etc., a fluidizing agent, a cleaning aid, etc., which are additives (hereinafter, also referred to as “external additives”), may be added (externally added).

Examples of the external additives include, for example, inorganic oxide fine particles such as silica fine particles, alumina fine particles and titanium oxide fine particles, inorganic stearate compound fine particles such as aluminum stearate fine particles and zinc stearate fine particles and inorganic titanate compound fine particles such as strontium titanate and zinc titanate. These external additives can be used with one type alone or with combining two or more types. To these inorganic particles, it is preferable that, with silane coupling agents, titanium coupling agents, higher fatty acids, silicone oils, etc., in order to improve heat storage resistance and environmental stability, a gloss process be performed. In addition, a BET specific surface area of the external additive is preferably 10 m²/g or more and 450 m²/g or less.

The BET specific surface area can be measured by a low temperature gas adsorption method using a dynamic constant pressure method according to a BET method (preferably a BET multi-point method). For example, the BET specific surface area (m²/g) can be calculated by using a specific surface area measuring device (trade name: Gemini 2375 Ver. 5.0, manufactured by Shimadzu Corporation) to make sample surfaces adsorb nitrogen gas and measuring the BET specific surface area using the BET multi-point method.

An addition amount of these various types of the external additives is, in total, relative to 100 parts by mass of the toner, preferably 0.05 parts by mass or more and 5 parts by mass or less, and more preferably 0.1 parts by mass or more and 3 parts by mass or less. In addition, as the external additives, various types thereof may be combined and used.

The developing roller 42 is a roller, in which a conductive elastic rubber layer having a predetermined volume resistance is provided on an outer periphery of a core metal made of metal, and is further configured so that a surface thereof has a predetermined surface roughness. For the developing roller 42, a roller of a single-layer structure or a roller of a multi-layer structure may be used. As a single-layer roller, for example, a roller in which an elastic layer is formed by rubber material such as silicone rubber, urethane rubber and hydrin rubber on a core metal thereof may be used. As a roller of the multi-layer structure, for example, a roller in which a surface layer is formed by silicone resin, urethane resin, polyamide resin, fluorine resin, etc. being coated on a surface of an elastic layer may be used.

In the present Embodiment, the developing roller 42 is rotationally driven in a direction of an arrow A3 (clockwise direction) in FIG. 3 by driving force transmitted from a motor, which is a driving source. In other words, the developing roller 42 is rotationally driven so that, in the opposing portion (contacting portion) between the developing roller 42 and the photosensitive drum 1, the surface (outer peripheral surface) of the developing roller 42 and the surface (outer peripheral surface) of the photosensitive drum 1 move in a forward direction. In the present Embodiment, the developing roller 42 is driven by the driving force being transmitted from the drum driving motor D1, however, a dedicated driving source for the developing roller 42 may be provided. In addition, in the present Embodiment, in order to obtain an appropriate image density, the developing roller 42 is rotationally driven at a rotation speed in which a moving speed (peripheral speed) of the surface of the developing roller 42 becomes, for example, about 130% relative to the moving speed (peripheral speed) of the surface of the photosensitive drum 1.

The supplying roller 43 is an elastic sponge roller in which a conductive foam member is formed on an outer periphery of a core metal thereof, which is made of metal. The supplying roller 43 is disposed so as to contact the developing roller 42 with a predetermined penetrating amount. In the present Embodiment, the supplying roller 43 includes a urethane foam layer (elastic foam member layer formed of a foam member of urethane rubber), and the urethane foam layer contains an ionic conductive agent. In the present Embodiment, the supplying roller 43 has a structure in which the ionic conductive agent, which is constituted by a salt of cation having a reactive functional group which reacts with an isocyanate group and anion, is chemically bonded to the urethane foam layer via the above reactive functional group. For example, by foam curing the urethane composition containing the ion conductive agent, the supplying roller 43 having such structure can be produced. By making the urethane of the surface layer be a continuous foam member (open cell foam), it becomes possible to make the toner be contained inside the supplying roller 43 and stably supply the toner to the developing roller 42. Incidentally, in the present Embodiment, an electrical resistance value of the supplying roller 43 is 1×10⁷Ω. In the present Embodiment, in the supplying and peeling-off portion F, the elastic foam member constituting the surface layer of the supplying roller 43 is compressed and crushed or squeezed by the developing roller 42.

Here, a measuring method for the electrical resistance value of the supplying roller 43 will be described. The supplying roller 43 is brought into contact with an aluminum sleeve having a diameter of 30 mm so as a penetrating amount to be 1.5 mm. By rotating the aluminum sleeve, the supplying roller 43 is rotationally driven relative to the aluminum sleeve at 30 rpm. Next, to the supplying roller 43, a direct current voltage of −50 V is applied. At this time, a resistor element of 10 kΩ is provided on a ground side, a current is calculated by measuring a voltage of both ends thereof, and the electrical resistance value of the supplying roller 43 is calculated.

In addition, in the present Embodiment, a cell diameter of a surface of the supplying roller 43 is 50-1000 μm. Here, the cell diameter refers to a mean diameter of foam cells in an arbitrary cross section, and can be calculated as follows First, from an enlarged image of the arbitrary cross section, an area of the foam cell which is the largest in the enlarged image is measured, and this area is converted to an equivalent diameter of a perfect circle, and a maximum cell diameter is obtained. Then, after removing the foam cells which is ½ of or less than the maximum cell diameter as noise, a mean value of each of the cell diameters converted from remaining each cell area in the same manner is calculated. The cell diameter means the mean value calculated in this manner.

In the present Embodiment, the supplying roller 43 is rotationally driven in a direction of an arrow A4 in FIG. 3 (clockwise direction) by driving force transmitted from a motor, which is a driving source. In other words, the supplying roller 43 is rotationally driven so that, in the opposing portion (contacting portion) of the supplying roller 43 and the developing roller 42, the surface (outer peripheral surface) of the supplying roller 43 and the surface (outer peripheral surface) of the developing roller 42 are moved in opposite directions. In the present Embodiment, the supplying roller 43 is driven by the driving force being transmitted from the drum driving motor D1, however, a dedicated driving source for the supplying roller 43 may be provided.

The regulating blade 44 is configured to include an elastic member having a plate shape, which has conductivity and flexibility. This elastic member, by one end portion thereof in a widthwise direction being fixed to the developing container (frame member) 41, is cantileveredly supported. And in the elastic member, the other end portion in the widthwise direction is configured to be a free end portion, and this free end portion is brought into contact with the surface (outer peripheral surface) of the developing roller 42. In addition, the regulating blade 44 is disposed so as to contact the surface (outer peripheral surface) of the developing roller 42 at a position on a downstream side in the moving direction (rotational direction) of the surface of the developing roller 42 from the opposing portion (contacting portion) between the supplying roller 43 and the developing roller 42. In the present Embodiment, as the elastic member of the regulating blade 44, a member made of SUS (stainless steel) is used. In addition, in the present Embodiment, the regulating blade 44 is brought into contact with the surface of the developing roller 42 with a side surface in a vicinity of a tip of the elastic member so that the tip on the free end portion side in the widthwise direction of the elastic member faces an upstream side in the moving direction of the surface of the developing roller 42. In other words, the regulating blade 44 is provided so as to face a counter direction with respect to the moving direction (rotational direction) of the surface of the developing roller 42.

In the present Embodiment, the stirring member 47 is configured to include a rotation shaft and a stirring portion having a sheet shape, which is attached to the rotation shaft. The stirring member 47 is rotatably supported by the developing container 41. The stirring member 47 is rotationally driven in a direction of an arrow A5 in FIG. 3 (clockwise direction) by driving force transmitted from a motor, which is a driving source. In the present Embodiment, the stirring member 47 is driven by the driving force being transmitted from the drum driving motor D1, however, a dedicated driving source for the stirring member 47 may be provided.

### <Bias Applied to the Developing Device>

To the developing roller 42, during image formation, etc., by the developing power source E2 as a developing voltage applying portion, a predetermined direct current voltage is applied. In addition, to the supplying roller 43, during image formation, etc., by the supplying power source E3 as a supplying voltage applying portion, a predetermined direct current voltage is applied. In addition, to the regulating blade 44, during image formation, etc., by the regulating power source E4 as a regulating voltage applying portion, a predetermined direct current voltage is applied. Here, the voltage (potential) applied to the developing roller 42 is referred to as a developing voltage (developing bias), the voltage (potential) applied to the supplying roller 43 is referred to as a supplying voltage (supplying bias), and the voltage (potential) applied to the regulating blade 44 is referred to as a regulating voltage (regulating bias).

In the present Embodiment, to the developing roller 42, the supplying roller 43 and the regulating blade 44, voltages depending on a temperature and a humidity of an installed environment of the image forming apparatus 100 are applied. As an example, in the present Embodiment, during image formation (during development), the developing voltage of −450 V is applied to the developing roller 42 and the regulating voltage of −550 V is applied to the regulating blade 44. At this time, a potential difference between the regulating blade 44 and the developing roller 42 becomes a polarity, in which the toner charged to the normal polarity is urged from the regulating blade 44 side to the developing roller 42 side. In other words, the potential of the regulating blade 44 becomes larger on the normal polarity side of the toner relative to the potential of the developing roller 42. By this, it becomes possible to stabilize intaking of the toner 90 into the contacting portion between the regulating blade 44 and the developing roller 42, and stabilize the application of the electric charge to the toner 90 by the regulating blade 44. In addition, in the present Embodiment, the image forming apparatus 100 is configured to be capable of changing the supplying voltage applied to the supplying roller 43 as desired. By this, it becomes possible for the image forming apparatus 100 to variably control the potential difference between the supplying roller 43 and the developing roller 42. As an example, in the present Embodiment, during image formation (during development), the developing voltage of −450 V is applied to the developing roller 42 and the supplying voltage of −550 V is applied to the supplying roller 43. At this time, the potential difference between the supplying roller 43 and the developing roller 42 becomes a polarity in which the toner charged to the normal polarity is urged (supplied) from the supplying roller 43 side to the developing roller 42 side. In other words, the potential of the supplying roller 43 becomes larger on the normal polarity side of the toner relative to the potential of the developing roller 42. By this, it becomes possible to supply the toner necessary for the image formation (development) to the developing roller 42 efficiently.

### <Mechanism for an Occurrence of Uneven Density Due to Peeling-Off Defect>

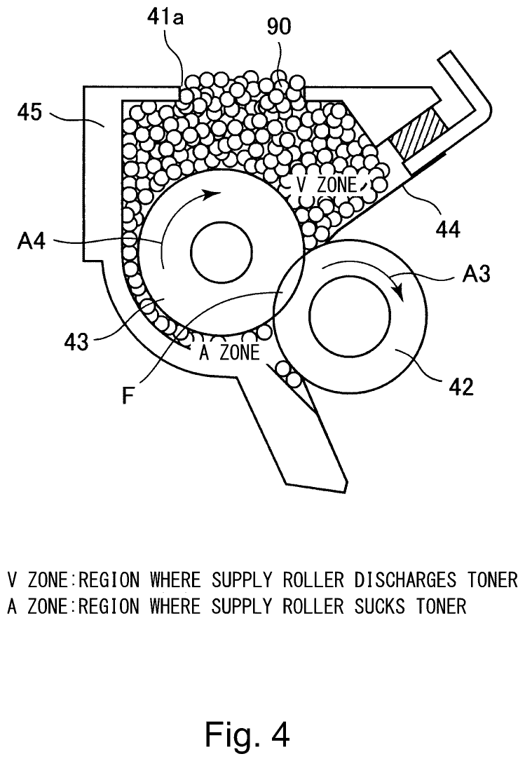

Next, a mechanism for an occurrence of image defect due to the peeling off of the toner from the developing roller 42 by the supplying roller 43 becoming insufficient will be described. FIG. 4 is a cross-sectional outline view of the developing chamber 45 to describe a behavior of the toner in the developing chamber 45.

In the present Embodiment, the developing chamber 45 is disposed on a lower side in the direction of gravity with respect to the toner accommodating chamber 46, and for the supply of the toner from the toner accommodating chamber 46 to the developing chamber 45, not only the conveyance force by the stirring member 47 but also gravity are utilized. Thus, when there is enough toner in the developing device 4, as shown in FIG. 4, an inside of the developing chamber 45 is in a state filled with the toner. The supplying roller 43 contacts the developing roller 42 with the penetrating amount. Therefore, in a vicinity of the position at which the supplying roller 43 is crushed or squeezed by the developing roller 42, in other words, in an area of a vicinity on an upstream side of the supplying and peeling-off portion F in the rotational direction of the supplying roller 43 (here, also referred to as a “V zone”), the supplying roller 43 discharges the toner. In addition, in a vicinity of a position at which the supplying roller 43 which has been crushed by the developing roller 42 is released, in other words, in an area of a vicinity on a downstream side of the supplying and peeling-off portion F in the rotational direction of the supplying roller 43 (here, also referred to as an “A zone”), the supplying roller 43 sucks or absorbs the toner. In the state in which the inside of the developing chamber 45 is filled with the toner as described above, the toner is substantially always present in the vicinity of the V zone, and the toner in the vicinity of the V zone is in a compacted state by weight of the toner in the toner accommodating chamber 46 being applied from above. In such a state, even if the supplying roller 43 attempts to discharge the toner in the V zone, since the toner is present in the vicinity of the V zone in the compacted state, it becomes difficult to discharge enough toner. In the state in which the toner cannot be sufficiently discharged in the V zone, the cells of the supplying roller 43 are filled with the toner, and it becomes difficult for the supplying roller 43 to peel off the toner on the developing roller 42. As a result, the toner amount on the developing roller 42 gets increased partially, and uneven density in the image may occur. Since this phenomenon is more likely to occur when the toner in the V zone is in the compacted state, as the toner amount in the developing device 4 becomes larger, this phenomenon becomes more likely to occur, and in addition, also in a case in which agglomerated degree of the toner is high, this phenomenon becomes more likely to occur. This image defect (uneven density due to the peeling-off defect) may be referred to as a “blurred image”, etc.

### <Preliminary Operation Before Image Formation>

Next, the preliminary operation before image formation in the present Embodiment will be described.

In the present Embodiment, the control portion 200 controls, before image formation, to perform the preliminary operation to change the potential difference between the developing roller 42 and the supplying roller 43 a plurality of number of times while driving the developing device 4 (rotating the developing roller 42, the supplying roller 43 and the stirring member 47). Incidentally, the potential difference includes a case in which the potential difference is approximately 0 V (approximately the same potential) as well. In other words, by performing the operation in which the potential difference between the developing roller 42 and the supplying roller 43 is switched before image formation, it becomes possible to apply vibration to the toner around the developing roller 42 and the supplying roller 43, which is in the compacted state, and loosen the toner.

By this, it becomes easier for the toner to be discharged from the supplying roller 43, and it becomes possible to make it easier for the supplying roller 43 to peel off the toner on the developing roller 42. Here, the above preliminary operation is, typically, performed after the start instruction of a job is input to the image forming apparatus 100 (control portion 200) and before the operation forming a first image (toner image to be transferred to one side (first side) of a first recording material P) in the job, or in more detail, the development of the image is performed. Hereinafter, it will be described in more detail.

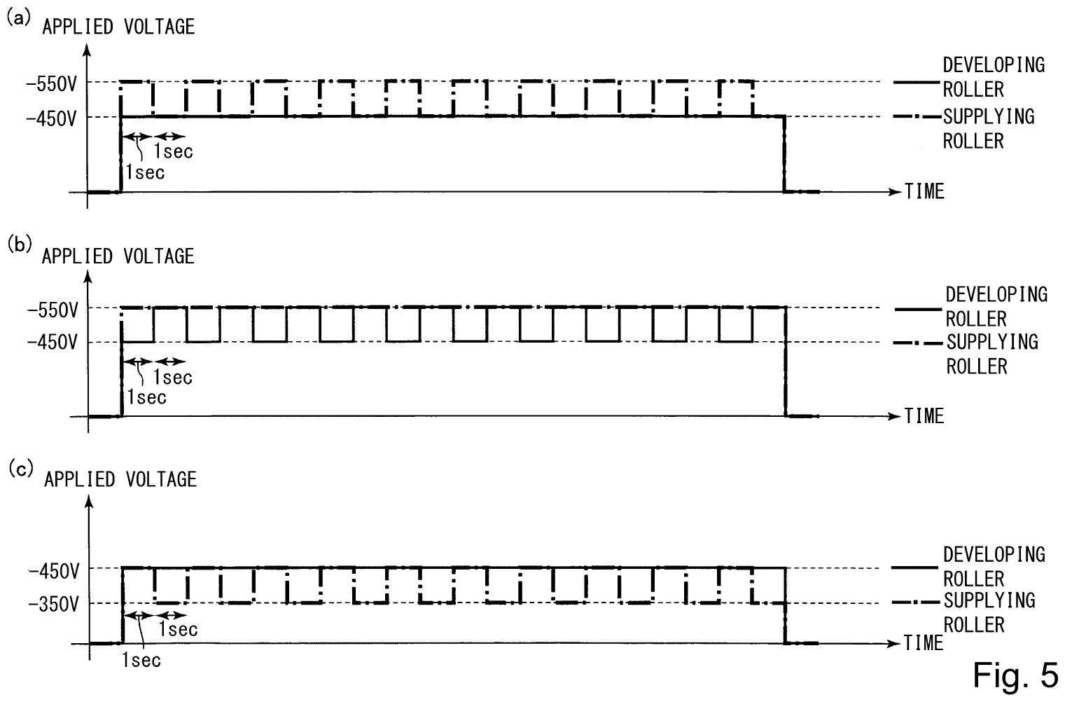

Part (a), part (b) and part (c) of FIG. 5 are timing chart diagrams showing specific examples of transitions of the potential of the developing roller 42 (developing voltage) and the potential of the supplying roller 43 (supplying voltage) during preliminary operation, respectively.

In an example shown in part (a) of FIG. 5, during preliminary operation, to the developing roller 42, the developing voltage of −450 V is applied. In addition, in the example shown in part (a) of FIG. 5, during preliminary operation, to the supplying roller 43, the supplying voltage of −550 V and the supplying voltage of −450 V are alternately applied every one second as a predetermined time. And in total, twenty times of the switching of the potential difference between the developing roller 42 and the supplying roller 43 are performed. When the supplying voltage of −550 V is applied to the supplying roller 43, the potential difference between the supplying roller 43 and the developing roller 42 is in the polarity in which the toner charged to the normal polarity is urged (supplied) from the supplying roller 43 side to the developing roller 42 side. In other words, the potential of the supplying roller 43 becomes larger on the normal polarity side of the toner relative to the potential of the developing roller 42. On the other hand, when the supplying voltage of −450 V is applied to the supplying roller 43, the potential difference between the supplying roller 43 and the developing roller 42 becomes approximately 0 V.

By performing such the switching of the potential difference between the developing roller 42 and the supplying roller 43, an electric field is formed between the supplying roller 43 and the developing roller 42 every one second. As a result, the toner in the V zone is subjected to force which moves the toner from the supplying roller 43 side to the developing roller 42 side every one second. By applying the intermittent force to the toner in the V zone, toner is vibrated, and it becomes possible to loosen the toner in the compacted state. As such, by performing the image formation in the state in which the toner in the V zone is loosened through the preliminary operation, it becomes possible for the supplying roller 43 to sufficiently discharge the toner in the V zone, and it becomes possible to suppress the occurrence of the uneven density due to the peeling-off defect.

In an example shown in part (b) of FIG. 5, during preliminary operation, to the supplying roller 43, the supplying voltage of −550 V is applied. In addition, in the example shown in part (b) of FIG. 5, during preliminary operation, to the developing roller 42, the developing voltage of −450 V and the developing voltage of −550 V are alternately applied every one second. And in total, twenty times of the switching of the potential difference between the developing roller 42 and the supplying roller 43 are performed. In this case as well, since the electric field formed between the developing roller 42 and the supplying roller 43 is substantially the same as in the example shown in part (a) of FIG. 5, the same effect as in the example shown in part (a) of FIG. 5 can be obtained.

In an example shown in part (c) of FIG. 5, during preliminary operation, to the developing roller 42, the developing voltage of −450 V is applied. In addition, in the example shown in part (c) of FIG. 5, during preliminary operation, to the supplying roller 43, the supplying voltage of −350 V and the supplying voltage of −450 V are alternately applied every one second. And in total, twenty times of the switching of the potential difference between the developing roller 42 and the supplying roller 43 are performed. In this case, since a strength of the electric field formed between the developing roller 42 and the supplying roller 43 is substantially the same as in the example shown in part (a) of FIG. 5, the toner in the V zone can be loosened. However, in this case, there is a possibility that another problem as follows occurs. In the present Embodiment, since the normal polarity of the toner is negative polarity, in the cases in which the supplying voltage is alternately switched between −350 V and −450 V, a portion of the toner charged to positive polarity is supplied to the developing roller 42. This is because when the supplying voltage of −350 V is applied to the supplying roller 43, the potential difference between the supplying roller 43 and the developing roller 42 is in the polarity in which the toner, which is charged to the reverse polarity to the normal polarity, is urged (supplied) from the supplying roller 43 side to the developing roller 42 side. Since the toner charged to positive polarity on the supplying roller 43 is not charged to the normal polarity, adhesion on the developing roller 42 tends to become weak due by charge amount being insufficient. If the developing roller 42 is rotated in this state, the toner on the developing roller 42 may fall off from the developing roller 42, and it may cause contamination, etc. inside the image forming apparatus 100 due to the toner to occur. There is a case in which this phenomenon is referred to as a “falling-off of the toner”, etc. Therefore, as for the supplying voltage during preliminary operation, to the developing voltage during preliminary operation, it is preferable to be the same value or larger value on the normal polarity side of the toner (negative polarity side in the present Embodiment).

Incidentally, in the present Embodiment, during preliminary operation, to the regulating blade 44, the same regulating voltage as during image formation is applied. However, it may be configured as the regulating voltage is not applied to the regulating blade 44 during preliminary operation, or configured as a different regulating voltage than during image formation is applied during preliminary operation.

### Effects of the Present Embodiment

Effects of the present Embodiment will be described. An Embodiment 1-1 is defined as a configuration in which the preliminary operation, which switches the potential difference, is performed as shown in part (a) of FIG. 5. An Embodiment 1-2 is defined as a configuration in which the preliminary operation, which switches the potential difference, is performed as shown in part (b) of FIG. 5. An Embodiment 1-3 is defined as a configuration in which the preliminary operation, which switches the potential difference, is performed as shown in part (c) of FIG. 5. A Comparative Example 1 is defined as a configuration in which, during preliminary operation, the constant developing voltage of −450 V is applied to the developing roller 42 and the constant supplying voltage of −550 V is applied to the supplying roller 43. And in each configuration, a halftone image of 25% density is printed after performing the preliminary operation, and presence or absence of the uneven density due to the peeling-off defect is checked. The results are shown in Table 1.

TABLE 1

| Configuration | Uneven density | Falling-off of toner |
|---|---|---|
| Embodiment 1-1 | Not occur | Not occur |
| Embodiment 1-2 | Not occur | Not occur |
| Embodiment 1-3 | Not occur | Occur |
| Comparative Example 1 | Occur | Not occur |

In the Embodiment 1-1 and the Embodiment 1-2, neither the uneven density due to the peeling-off defect nor the falling-off of the toner from the developing roller 42 occurred.

In the Embodiment 1-3, the uneven density due to the peeling-off defect did not occur, but the falling-off of the toner from the developing roller 42 occurred in some cases. Incidentally, in a case in which, for example, it is possible to prioritize the suppression of the uneven density due to the peeling-off defect, it can be configured as in the Embodiment 1-3. However, since it is possible to suppress the uneven density due to the peeling-off defect and suppress the falling-off of the toner from the developing roller 42, the configuration as in the Embodiment 1-1 and the Embodiment 1-2 are more preferable.

In the Comparative Example 1, the uneven density due to the peeling-off defect occurred. It can be considered that because it is not possible to loosen the toner, which is in the compacted state, around the developing roller 42 and supplying roller 43 by applying vibration. Incidentally, in the Comparative Example 1, the falling-off of the toner from the developing roller 42 did not occur.

As described above, in the present Embodiment, during non-image formation in which the development is not performed, in the state in which the developing roller 42 and the supplying roller 43 rotate, the control portion 200 is capable of controlling the developing power source E2 and the supplying power source E3 so as to perform the preliminary operation in which a first potential difference and a second potential difference different from the first potential difference are formed between the developing roller 42 and the supplying roller 43 and alternately switched for a plurality of number of times. By this, it becomes possible to loosen the compacted state of the toner around the supplying roller 43 and developing roller 42, and make it easier for the toner to be discharged from the supplying roller 43. As a result, it becomes easier for the supplying roller 43 to peel off the toner on the developing roller 42, and it becomes possible to suppress the occurrence of the uneven density due to the peeling-off defect.

Incidentally, in the present Embodiment, the number of times of the switching of the potential difference between the developing roller 42 and the supplying roller 43 during preliminary operation is set to twenty times, however, it is not limited thereto. This number of times can be set as appropriate according to the flowability of the toner, the configuration of the developing device 4, etc., for example. Similarly, as for the aforementioned predetermined time, for which each voltage (potential) is applied, as well, it is not limited to one second in the present Embodiment, but can be set as appropriate according to the flowability of the toner and the configuration of developing device 4, etc., for example. When this predetermined time becomes too short, it may become difficult for the movement of the toner to follow the switching of directions of the electric field, and it may become difficult to loosen the toner. In addition, when this predetermined time is too long as well, it may become difficult to vibrate and loosen the toner. It is not limited to this, however, this predetermined time is preferably, for example, about 0.5 second or longer and two seconds or shorter. In addition, it is not necessary for this predetermined time to be constant in the single preliminary operation or between a plurality of the preliminary operations.

In addition, in the present Embodiment, during preliminary operation, to the supplying roller 43, the supplying voltage of −450 V and the supplying voltage of −550 V are alternately applied, for example, however, a value of the supplying voltage during the preliminary operation is not limited to the value in the present Embodiment. For example, it may be configured as, during preliminary operation, to the supplying roller 43, the supplying voltage of −450 V and the supplying voltage of −650 V are alternately applied. By this, by making the potential difference between the developing roller 42 and the supplying roller 43 during the preliminary operation larger than in the present Embodiment, it becomes possible to make the vibration applied to the toner in the V zone stronger than in the present Embodiment. This potential difference can be set as appropriate according to the flowability of the toner and the configuration of the developing device 4, for example. It is not limited to this, however, it is preferable that the potential difference by which the potential of the supplying roller 43 is larger on the normal polarity side of the toner relative to the potential of the developing roller 42 be at least the potential difference during image formation or more (typically, three times or lower than the potential difference during image formation). In addition, in a case in which the potential difference is set to the first potential difference, the second potential difference is preferably approximately 0 V (the developing roller 42 and the supplying roller 43 have approximately the same potential). As an example, a difference between the first potential difference and the second potential difference is preferably about 100-300 V. Incidentally, it may also be possible to alternately switch between the first potential difference and the second potential difference, in which the potential of the supplying roller 43 becomes larger on the normal polarity side of the toner to the potential of the developing roller 42, respectively.

In addition, for example, depending on an environment in which the image forming apparatus 100 is installed, the number of times of the switching of the potential difference between the developing roller 42 and the supplying roller 43 during preliminary operation may be changed. As described above, as the toner in the V zone becomes more compacted state, it tends to be more likely for the uneven density due to the peeling-off defect to occur. Thus, for example, in a higher humidity environment, the number of times of the switching of the potential difference can be increased. In addition to or instead of increasing the number of times of the switching of the potential difference, the potential difference may be increased as described above.

In addition, at least one of the rotation speeds (peripheral speeds) of the developing roller 42 and the supplying roller 43 may be set more faster during preliminary operation than during image formation. By this, improvement of the effect to loosen the toner around the developing roller 42 and the supplying roller 43 can be expected.

In addition, in the present Embodiment, the preliminary operation is performed every time before the image formation, however, a frequency to perform the preliminary operations is not limited thereto. For example, in a case in which a standing time of the image forming apparatus 100 since a termination of a previous image formation is short, a degree of the compacted state of the toner in the V zone may be low, and there may be less need to perform the preliminary operation. Therefore, it may be configured as follows. For example, to the image forming apparatus 100, a timer as a measuring means which measures a time (standing time) from the termination of the previous image formation (e.g., when the drive of the developing device 4 is stopped) until a start of a current image formation (e.g., when the start instruction of the job is input or when the drive of the developing device 4 is started) is provided. And it is configured that if the standing time measured by this timer exceeds a predetermined threshold value, then the preliminary operation is performed before the image formation. In addition, from a similar perspective, depending on the standing time, the number of times of the switching of the potential difference between the developing roller 42 and the supplying roller 43 during the preliminary operation may be changed. In this case, for example, as the standing time gets longer, the number of times of the switching of the potential difference can be increased. In this case as well, in addition to or instead of increasing the number of times of the switching of the potential difference, the potential difference may be increased as described above.

In addition, in the present Embodiment, the image forming apparatus 100 performs the preliminary operation from the input of the start instruction of the job until the start of the first image formation, however, it is not limited thereto. For example, the image forming apparatus 100 may perform the same operation as the preliminary operation in the present Embodiment at a predetermined frequency (e.g., every predetermined time) while the image forming apparatus 100 is waiting for the start instruction of the job (while the image forming apparatus 100 is left standing).

As described above, in the present Embodiment, the image forming apparatus 100 includes the rotatable image bearing member (photosensitive drum) 1, the developing device 4 configured to develop the electrostatic latent image formed on the surface of the image bearing member 1 with the toner, the developing device 4 including the rotatable developing member (developing roller) 42 configured to supply the toner to the electrostatic latent image and the rotatable supplying member (supplying roller) 43 in contact with the developing member 42 and configured to supply the toner to the developing member 42, the developing voltage applying portion (developing power source) E2 configured to apply the voltage to the developing member 42, the supplying voltage applying portion (supplying power source) E3 configured to apply the voltage to the supplying member 43, and the control portion 200 configured to control the developing voltage applying portion E2 and the supplying voltage applying portion E3, and during non-image formation in which the development is not performed, in the state in which the developing member 42 and the supplying member 43 rotate, the control portion 200 is capable of controlling the developing voltage applying portion E2 and the supplying voltage applying portion E3 so as to perform the preliminary operation in which the first potential difference and the second potential difference different from the first potential difference are formed between the developing member 42 and the supplying member 43 and alternately switched for a plurality of number of times. In the present Embodiment, the control portion 200 controls to perform the preliminary operation from input of the start instruction of the job, in which the image is formed on a single or a plurality of the recording materials P and is output, until start of the development of the electrostatic latent image corresponding to a first image in the job. In addition, in the present Embodiment, the control portion 200 controls so that the voltage to be applied to the supplying member 43 becomes larger on the normal polarity side of the toner relative to the voltage to be applied to the developing member 42 when at least one of the first potential difference and the second potential difference is formed. In addition, in the present Embodiment, the control portion 200 controls so that the voltage to be applied to the supplying member 43 and the voltage to be applied to the developing member 42 becomes substantially the same when at least one of the first potential difference and the second potential difference is formed. In addition, in the present Embodiment, the developing device 4 includes the developing chamber 45 provided with the developing member 42 and the supplying member 43, and the toner accommodating chamber 46 in which the toner supplied to the developing chamber 45 is accommodated, and the developing chamber 45 is disposed at the lower side of the toner accommodating chamber 46 in the direction of gravity.

In addition, the control portion 200 can control to change the number of times for which the potential difference are alternately switched to the first potential difference and to the second potential difference during preliminary operation based on information regarding the time from the stop of the rotation of the developing member 42 with the termination of the previous job until the start of the rotation of the developing member 42 with the start of the current job. In this case, when the time indicated by the information is the first time and the second time longer than the first time, the control portion 200 can control so that the number of times is larger in the case in which the time is the second time than in the case in which the time is the first time. In addition, the control portion 200 can control the driving device which rotates at least one of the developing member 42 and the supplying member 43 so that the rotation speed of at least one of the developing member 42 and the supplying member 43 becomes faster during the preliminary operation than during image formation in which the development is performed.

And according to the present Embodiment, it becomes possible to suppress the occurrence of the image defect due to the peeling-off of the toner from the developing member 42 with the supplying member 43 becoming insufficient.

Next, another Embodiment (Embodiment 2) of the present invention will be described. Basic configurations and operations of an image forming apparatus in the present Embodiment are the same as those in the Embodiment 1. Therefore, in the image forming apparatus in the present Embodiment, to those elements having functions or configurations that are the same as or corresponding to the image forming apparatus in the Embodiment 1, the same reference numerals as in the Embodiment 1 will be attached, and detailed description thereof will be omitted.

### Outline of the Present Embodiment

In the present Embodiment, the number of times of the switching of the potential difference between the developing roller 42 and the supplying roller 43 during preliminary operations is changed according to usage history information of the developing device 4.

As described in the Embodiment 1, the uneven density due to the peeling-off defect is more likely to occur as the toner amount in the developing device 4 becomes larger and the degree of agglomeration of the toner in the developing device 4 becomes higher. In other words, when the toner amount in the developing device 4 is large, the toner in the V zone is more likely to become compacted state by its own weight. In addition, when the degree of agglomeration of the toner is high, it makes difficult for the toner in the V zone to be moved. Therefore, in these cases, it becomes difficult for the supplying roller 43 to discharge the toner in the V zone, and it becomes more likely for the uneven density due to the peeling-off defect to occur.

Therefore, in the present Embodiment, the control portion 200 controls, according to the toner amount in the developing device 4 and deterioration degree of the toner in the developing device 4, to change the number of times of the switching of the potential difference between the supplying roller 43 and the developing roller 42 during preliminary operation.

### <Calculation of a Remaining Amount of the Toner>

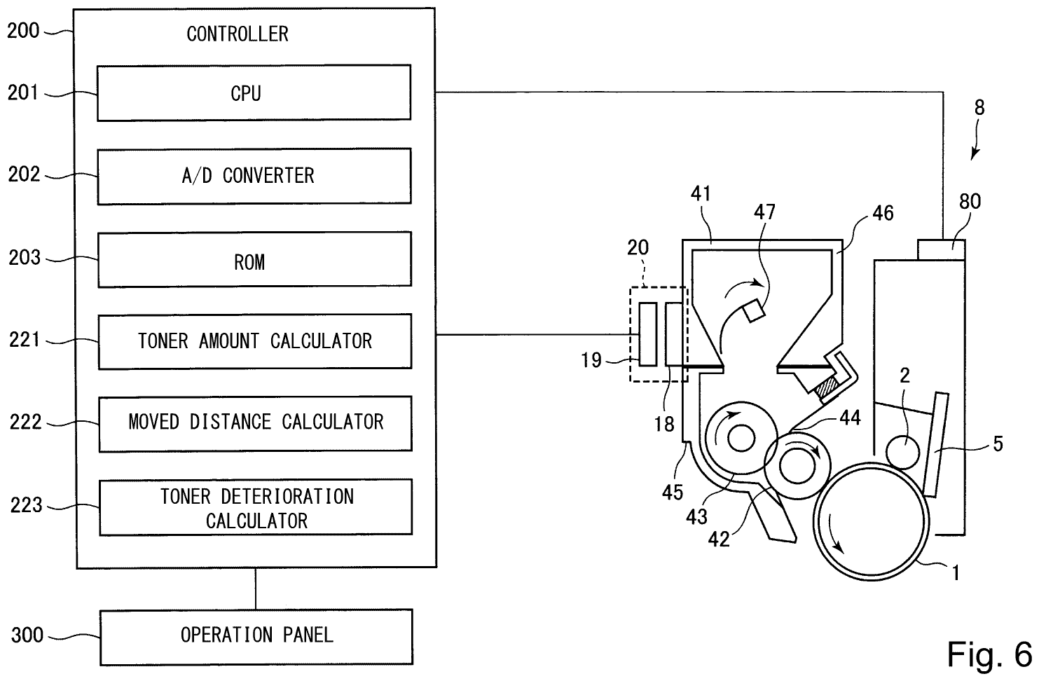

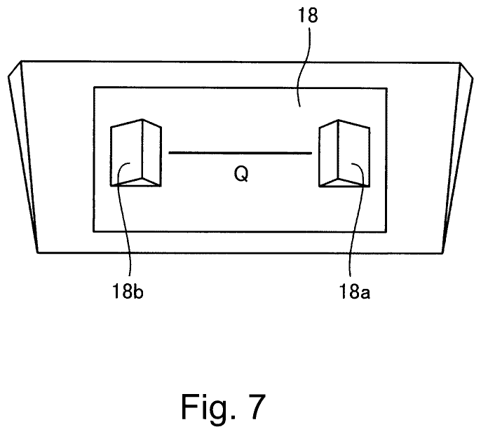

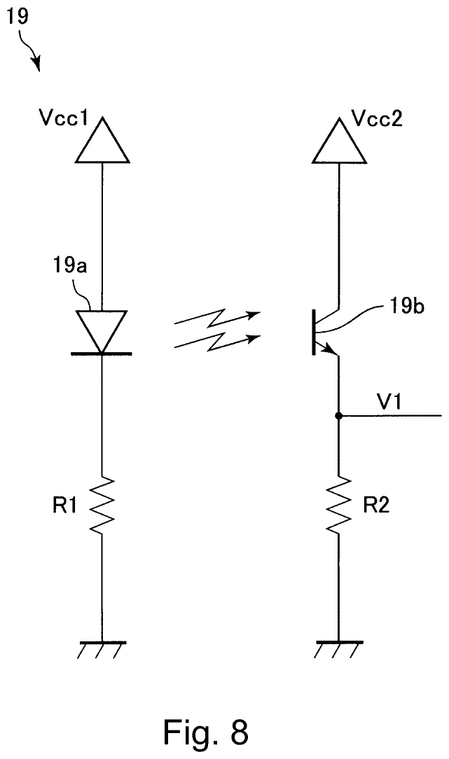

Next, a configuration for detecting the toner amount in the developing device 4 (remaining amount of the toner) in the present Embodiment will be described. FIG. 6 is a schematic view illustrating a configuration for detecting the remaining amount of the toner in the developing device 4 in the present Embodiment. FIG. 7 is a schematic view of a light guide member 18 constituting a toner amount sensor 20, which will be described below. In addition, FIG. 8 is a schematic view illustrating a circuit configuration of the toner amount sensor 20.

As shown in FIG. 6, to the developing device 4, the light guide member 18 constituting the toner amount sensor 20 as a developer remaining amount detecting means is provided. As shown in FIG. 7, the light guide member 18 includes a light emitting side light guide portion 18a and a light receiving side light guide portion 18b. The light emitting side light guide portion 18a guides a light emitted from a light emitting element 19a of a sensor portion 19, which will be described below, to the inside of the developing container 41 (toner accommodating chamber 46 in the present Embodiment). The light receiving side light guide portion 18b guides the light, which has passed through the light emitting side light guide portion 18a and a spatial optical passage Q inside the developing container 41, to a light receiving element 19b of the sensor portion 19, which will be described below.

In addition, as shown in FIG. 6, to the apparatus main assembly 110, the sensor portion 19 constituting the toner amount sensor 20 is provided. As shown in FIG. 8, the sensor portion 19 includes the light emitting element 19a as a light emitting portion which emits a light and the light receiving element 19b as a light receiving portion which receives the light emitted from the light emitting element 19a. In addition, the sensor portion 19 includes a substrate (not shown) onto which the light emitting element 19a and the light receiving element 19b are provided. In the present Embodiment, an LED is used as the light emitting element 19a and a phototransistor is used as the light receiving element 19b. This phototransistor becomes an ON state by a light from the LED. In addition, a cable connector (not shown) is provided to the substrate. The sensor portion 19 is connected, via this cable connector, by a cable (not shown) to the control portion 200 provided to the apparatus main assembly 110.

Next, disposition of the toner amount sensor 20 in the present Embodiment will be described. In the present Embodiment, the toner amount sensor 20, which is constituted by the light guide member 18 and the sensor portion 19, is disposed on a side surface of the toner accommodating chamber 46 of the developing device 4. In the present Embodiment, the toner amount sensor 20 (light guide member 18 and the sensor portion 19) is disposed at a central portion in a longitudinal direction of the toner accommodating chamber 46 (rotational axis direction of the developing roller 42). The toner inside the toner accommodating chamber 46 may be distributed unevenly in the longitudinal direction of the toner accommodating chamber 46, but at the central portion in the longitudinal direction of the toner accommodating chamber 46, the uneven distribution of the toner is less likely. Therefore, by providing the toner amount sensor 20 (light guide member 18 and the sensor portion 19) at the central portion in the longitudinal direction of the toner accommodating chamber 46, it becomes possible to suppress effect from the uneven distribution of the toner on detection results of the remaining amount of the toner.

Next, a detection method for the toner amount with the toner amount sensor 20 will be described. In FIG. 8, between the light emitting element 19a and a power source voltage Vcc1, a switch (not shown) is provided. By this switch being turned into an ON state, a voltage from the power source voltage Vcc1 is applied to the light emitting element 19a, and the light emitting element 19a is made to be in a conduction state. On the other hand, between the light receiving element 19b and a power source voltage Vcc2 as well, a switch (not shown) is provided. By this switch being turned into an ON state, the light receiving element 19b is made to be in a conduction state, and a current corresponding to a light amount detected by the light receiving element 19b flows.

To the light emitting element 19a, the power source voltage Vcc1 and a current limiting resistor R1 are connected, and the light emitting element 19a emits the light due to a current determined by the current limiting resistor R1. The light emitted from the light emitting element 19a passes through the spatial optical passage Q and is received by the light receiving element 19b. To a collector terminal of the light receiving element 19b, the power source voltage Vcc2 is connected, and to an emitter terminal of the light receiving element 19b, a detection resistor R2 is connected. The light receiving element 19b, which is the phototransistor, receives the light emitted from the light emitting element 19a, and outputs a signal (current) corresponding to a received light amount. This signal is converted to a voltage by the detection resistor R2, and input to an A/D converting portion 202 of the control portion 200, which will be described below. In other words, the light receiving element 19b changes output values depending on the toner amount accommodated in the toner accommodating chamber 46. To the toner amount sensor 20, electric power from a power source provided to the image forming apparatus 100 is supplied.

As shown in FIG. 6, the control portion 200 includes the CPU 201, the A/D converting portion 202, a ROM 203, and a toner amount calculating portion 221. The A/D converting portion 202 may be configured as a part of the input/output portion described above. In addition, the ROM 203 may be configured as a part of the main assembly storage portion 210 described above. In the present Embodiment, functions of the toner amount calculating portion 221 is realized by the CPU 201 performing programs stored in the ROM 203. However, all or a part of the functions of the toner amount calculating portion 221 may be realized by a hardware circuit such as an ASIC (application specific integrated circuit) and an FPGA (field programmable array). In addition, to the process cartridge 8, a cartridge memory (hereinafter, simply referred to as a “memory”) constituted by a nonvolatile memory as a storage means (storage portion) is provided. In addition, to the control portion 200, an operation panel (operating portion) 300 provided to the apparatus main assembly 110 is connected. The operation panel 300 is configured to include a display portion for displaying information to a user (an operator) through control of the control portion 200 and an input portion for inputting information to the control portion 200 in response to operation from the user (operator). The operation panel 300 may be configured to include a touch panel, etc., which has the function of the display portion and the function of the input portion.

The toner amount calculating portion 221 of the control portion 200 determines, based on a voltage level, which is input to the control portion 200 by the toner amount sensor 20 and converted to a digital signal by the A/D converting portion 202, whether or not the light receiving element 19b receives the light from the light emitting element 19a. And the toner amount calculating portion 221 calculates, upon the toner in the developing device 4 (the toner accommodating chamber 46 in the present Embodiment) being stirred by the stirring member 47 for a predetermined time, a length of time during which the toner amount sensor 20 detects the light. In the ROM 203 of the control portion 200, toner amount determining information for determining (calculating, predicting, estimating) the toner amount is stored in advance as a table showing relationship between the time described above and the toner amount. And the toner amount calculating portion 221 calculates the toner amount in the developing device 4 based on the voltage level, which is input to the control portion 200 by the toner amount sensor 20 and converted by the A/D converting portion 202, and the table information.

More specifically, the spatial optical passage Q of the toner amount sensor 20 is set so as to cross a rotational locus of the stirring member 47 as viewed along a rotational axis direction of the stirring member 47 in the toner accommodating chamber 46. And a time during which the spatial optical passage Q is blocked by the toner conveyed by the stirring member 47 upon the stirring member 47 being rotated once, in other words, a time during which the light receiving element 19b does not detect the light from the light emitting element 19a, varies depending on the remaining amount of the toner in the developing device 4. In addition, received light intensity at the light receiving element 19b also varies depending on the remaining amount of the toner in the developing device 4.

In short, when the remaining amount of the toner is small, since the time during which the spatial optical passage Q is blocked by the toner is short, the time during which the light receiving element 19b is receiving the light becomes long, and the received light intensity of the light received by the light receiving element 19b becomes strong. On the other hand, when the remaining amount of the toner is large, to the contrary, the time during which the light receiving element 19b is receiving the light becomes short, and the received light intensity of the light received by the light receiving element 19b becomes weak. Thus, the control portion 200 can determine, based on the light receiving time or the received light intensity of the light receiving element 19b, a level of the remaining amount of the toner.

In the present Embodiment, when the image formation is performed, a toner amount T most recently detected by the toner amount sensor 20 upon a termination of the image formation is calculated by the toner amount calculating portion 221, and this toner amount T is stored in the memory 80. In addition, in the memory 80, a toner amount TM accommodated in the toner accommodating chamber 46 when the developing device 4 (process cartridge 8) is new and a toner amount TL upon toner out are stored in advance. The toner amount TL upon the toner out is a predetermined toner amount in the developing device 4 in a case in which the remaining amount of the toner in the developing device 4 is decreased to such an extent that an exchange of the developing device 4 (process cartridge 8) is recommended. The toner amount TL upon the toner out may be substantially 0 g or a predetermined toner amount more than 0 g. The toner amount calculating portion 221 calculates a remaining amount of the toner TJ [%] as toner amount information according to the following equation (1).

$$TJ [ \% ] = ( 1 - T / ( TM - TL ) ) \times 100 \qquad ( 1 )$$

The control portion 200 determines, if the remaining amount of the toner TJ>0%, then that the toner is present, and controls to display a value of the remaining amount of the toner TJ on the operation panel 300. In addition, the control portion 200 determines, if the remaining amount of the toner TJ≤0%, then that the toner is absent (toner out), and controls to display information (warning), which urges the user for the exchange of the process cartridge 8 including the developing device 4, on the operation panel 300. Incidentally, the control portion 200 may also control to perform a similar display on the external device. In addition, the control portion 200 may also control to display information regarding the remaining amount of the toner TJ in response to an instruction (signal) which is input based on operation from the user (operator) through the operation panel 300 or the external device. In addition, in the present Embodiment, the toner amount information is dealt on a basis of the remaining amount of the toner TJ, however, it may also be dealt on a basis of a toner usage amount. In other words, when the remaining amount of the toner TJ is 0%, the toner usage amount is 100%, and when the remaining amount of the toner TJ is 100%, the toner usage amount is 0%, and a usable toner amount may be stored in the memory 80 in advance.

Incidentally, the detection/estimation method for the remaining amount of the toner is not limited to the optical detection type described above, but any detection/estimation method for the remaining amount of the toner such as a known type, for example, can be employed. For example, an electrostatic capacitance detection type, a weight detection type, a video count detection type, etc. are known. The electrostatic capacitance detection type is a type as follows. A plurality of electrodes, for example, two or more of metal plates or conductive resin sheets extending in the longitudinal direction of the developing roller are disposed on an inner wall of the developing container, which is the frame member. And an electrostatic capacitance between the metal plates or between the conductive resin sheets is measured, and based on this electrostatic capacitance, the remaining amount of the toner is detected/estimated. In addition, the weight detection type is a type as follows. For example, a load cell is provided so as to support the developing device from a lower direction. And by subtracting a weight of the developing device when the toner in the developing device is empty from a weight measured by the load cell, the remaining amount of the toner is detected/estimated. In addition, the video count type is a type also follows. Based on the image information regarding the image formation, a video count, which is correlated with a number of pixels in the image portion (or a toner application amount onto the image portion), is measured. And a usage amount of the toner is detected/estimated based on a value of the video count, and the remaining amount of the toner is detected/estimated.

### <Calculation of the Deterioration Degree of the Toner>

As for the toner in the developing device 4, due to rubbing between the developing roller 42 and the regulating blade 44 and rubbing between the developing roller 42 and the supplying roller 43, the external additive are peeled off, and degradation in flowability and chargeability (here, also referred to as “toner deterioration”) occurs. As a moved distance of the surface of the developing roller 42 increases, the number of times of the rubbing of the toner increases, and the toner deterioration progresses, however, rates of the progress vary depending on the toner amount in the developing device 4. Comparing cases in which the toner amount in the developing device 4 is large and small, even when the moved distance of the surface of the developing roller 42 is the same, since the number of rubbing increases in the case in which the toner amount in the developing device 4 is small, the deterioration of the toner progresses more quickly.

Next, a calculation method for the deterioration degree of the toner in the present Embodiment will be described. In the present Embodiment, the control portion 200 refers to the remaining amount of the toner TJ in the developing device 4 each time the image is formed on one sheet of the recording material P (in more detail, on one side of one sheet of the recording material P). And the control portion 200 calculates the deterioration degree of the toner, using a toner deterioration correcting coefficient k corresponding to the remaining amount of the toner TJ, based on the moved distance of the surface W of the developing roller 42.

As shown in FIG. 6, the control portion 200 includes a calculating portion for the moved distance of the surface of the developing roller (hereinafter, simply referred to as a “distance calculating portion”) 222, and a toner deterioration degree calculating portion 223. The distance calculating portion 222 measures the moved distance of the surface W of the developing roller 42. The toner deterioration degree calculating portion 223 calculates, using the toner deterioration correcting coefficient k, the deterioration degree of the toner based on the moved distance of the surface W of the developing roller 42. In the present Embodiment, functions of the distance calculating portion 222 and the toner deterioration degree calculating portion 223 are realized by the CPU 201 performing programs stored in the ROM 203. However, all or a part of the functions of the distance calculating portion 222 and the toner deterioration degree calculating portion 223 may be realized by a hardware circuit such as an ASIC (application specific integrated circuit) and an FPGA (field programmable array).

The distance calculating portion 222 measures the moved distance of the surface W based on a drive time of the developing device 4 (rotation time of the developing roller 42, the supplying roller 43 and the stirring member 47) Td, a process speed Ps of the image forming apparatus 100, and a peripheral speed ratio Sr of the developing roller 42 to the photosensitive drum 1. Here, the moved distance of the surface W is a distance which represents how much a certain point on the surface of the developing roller 42 is advanced by the rotation of the developing roller 42. In addition, the process speed Ps of the image forming apparatus 100 is the moving speed (peripheral speed) of the photosensitive drum 1. Specifically, the moved distance of the surface W of the developing roller 42 is obtained through the following equation (2).

$$W = Td \times Ps \times Sr \qquad ( 2 )$$

Incidentally, as long as it is information regarding the moved distance of the surface of the developing roller 42, it is not limited to the parameters described above, but a number of rotation of the developing roller 42, etc. may also be used.

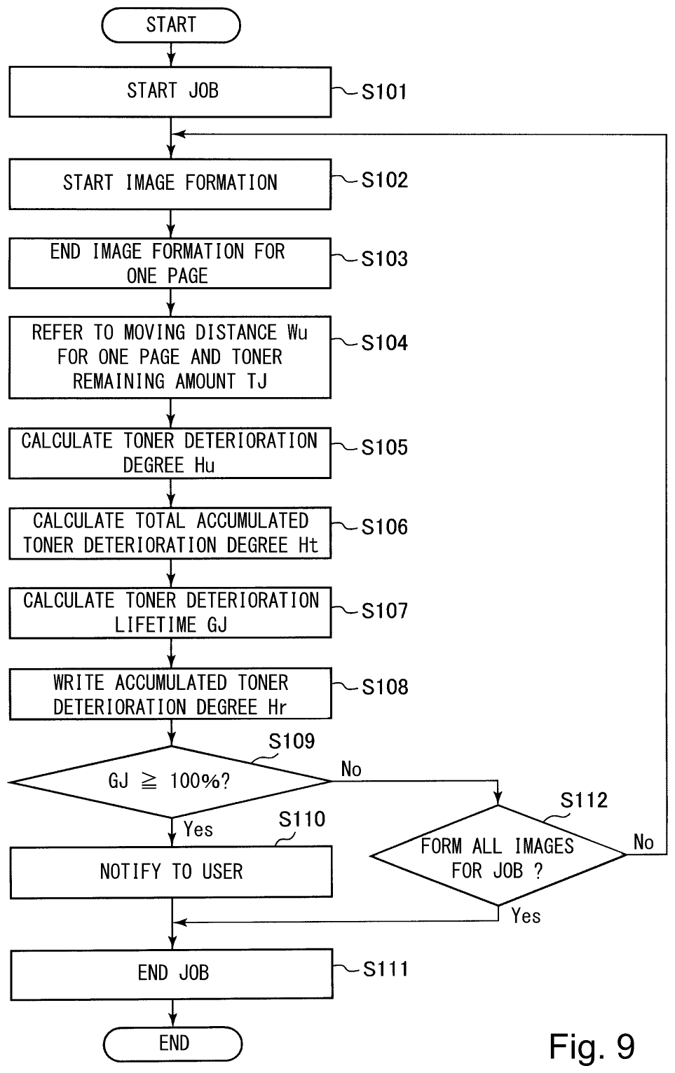

FIG. 9 is a flowchart diagram illustrating an example of a procedure for calculating the deterioration degree of the toner in the present Embodiment. Here, it will be described with omitting the execution of the preliminary operation. The control portion 200 controls, upon the start instruction of the job (print signal) being input, to start the operation for the job and start the drive of the developing device 4 (S101). Thereafter, the control portion 200 controls to start the image formation (S102). When the image formation for one sheet of the recording material P is completed (S103), the toner deterioration degree calculating portion 223 of the control portion 200 refers to a moved distance of the surface Wu of the developing roller in the image formation for one sheet of the recording material P and the remaining amount of the toner TJ (S104). The moved distance of the surface Wu of the developing roller in the image formation for one sheet of the recording material P is calculated by the distance calculating portion 222 of the control portion 200. In addition, the remaining amount of the toner TJ has been calculated by the toner amount calculating portion 221 of control portion 200 and stored in the memory 80. And the toner deterioration degree calculating portion 223 reads out the toner deterioration correcting coefficient k, which corresponds to the remaining amount of the toner TJ and has been stored in the memory 80. Values for the toner deterioration correcting coefficient k in the present Embodiment are shown in Table 2. In the present Embodiment, information showing relationship between the remaining amount of the toner TJ and the toner deterioration correcting coefficient k, as shown in Table 2, is set in advance and stored as a table in the memory 80. By setting the toner deterioration correcting coefficient k to becomes larger as the remaining amount of the toner TJ becomes smaller, it becomes possible to reflect the phenomenon that the deterioration of the toner progresses as the remaining amount of the toner TJ becomes smaller.

TABLE 2

| Remaining amount | Toner deterioration |
|---|---|
| of toner TJ | correcting coefficient k |
| 100%-41% | 1.00 |
| 40%-31% | 1.78 |
| 30%-21% | 2.22 |
| 20%-11% | 3.85 |
| 10%-0% | 6.15 |

Then, the toner deterioration degree calculating portion 223 functions as a corrected distance acquiring portion, and calculates a deterioration degree of the toner Hu by multiplying the moved distance of the surface Wu of the developing roller in the image formation for one sheet of the recording material P by the toner deterioration correcting coefficient k (S105). Specifically, the deterioration degree of the toner Hu is obtained through the following equation (3).

$$Hu = k \times Wu \qquad ( 3 )$$

Next, the toner deterioration degree calculating portion 223 calculates a total accumulated added deterioration degree of the toner Ht by adding (integrating) the deterioration degree of the toner Hu to an accumulated deterioration degree of the toner Hr from a start of use (upon being new) of the process cartridge 8, which is stored in the memory 80 (S106). Specifically, the total accumulated added deterioration degree of the toner Ht is obtained through the following equation (4).

$$Ht = Hr + Hu \qquad ( 4 )$$

In addition, the toner deterioration degree calculating portion 223 calculates, based on a toner deterioration degree threshold value Wth, which is stored in the memory 80, and the total accumulated added deterioration degree of the toner Ht, a toner deterioration lifetime GJ as deterioration degree information (S107). Specifically, the toner deterioration lifetime GJ is obtained through the following equation (5).

$$GJ [ \% ] = Ht / Wth \times 100 \qquad ( 5 )$$

And the toner deterioration degree calculating portion 223 writes the total accumulated added deterioration degree of the toner Ht as the accumulated deterioration degree of the toner Hr into the memory 80 (S108).

Here, if the toner deterioration lifetime GJ=0%, then it is indicated that the developing device 4 is new. In addition, if the toner deterioration lifetime GJ≥100% (i.e., if the total accumulated added deterioration degree of the toner Ht exceeds the toner deterioration threshold value Wth), then it can be determined that the developing device 4 has reached an end of life thereof and it is time to exchange the process cartridge 8.

The control portion 200 determines whether or not the toner deterioration lifetime GJ≥100% (S109). And if the control portion 200 determines in S109 that the toner deterioration lifetime GJ≥100%, then controls to display information (warning), which urges the user for the exchange of the process cartridge 8, on the operation panel 300 (S110). Incidentally, the control portion 200 may also control to perform a similar display on the external device. In addition, the control portion 200 controls to terminate the operation for the job (S111). On the other hand, if the control portion 200 determines in S109 not that the toner deterioration lifetime GJ≥100%, then determines whether or not a next image formation of the job is scheduled (S112), and if so, then performs the next image formation (S102), and if not, then controls to terminate the operation for the job (S111).

### <Control for the Preliminary Operation>

Next, control for the preliminary operation prior to the image formation in the present Embodiment will be described. As described above, the uneven density due to the peeling-off defect is more likely to occur as the toner amount in the developing device 4 is large, and in addition, as the degree of agglomeration of the toner becomes higher, the uneven density becomes more likely to occur. In the configuration in the present Embodiment, with setting each of the remaining amount of the toner TJ and the toner deterioration lifetime GJ in different conditions, the numbers of times of the switching of the potential difference between the developing roller 42 and the supplying roller 43, with which it becomes possible to sufficiently suppress the uneven density due to the peeling-off defect, are determined from experiments. Obtained relationship among the remaining amount of the toner TJ, the toner deterioration lifetime GJ and the number of times of the switching of the potential difference is shown in Table 3.

TABLE 3

| | | Toner deterioration lifetime GJ | | | | | |
|---|---|---|---|---|---|---|---|
| | | 0% | 20% | 40% | 60% | 80% | 100% |
| Re- | 100% | 10 times | 12 times | 14 times | 16 times | 18 times | 20 times |
| maining | 80% | 6 times | 8 times | 10 times | 12 times | 14 times | 16 times |
| amount | 60% | 2 times | 4 times | 6 times | 8 times | 10 times | 12 times |
| of toner | 40% | 0 times | 0 times | 2 times | 4 times | 6 times | 8 times |
| TJ | 20% | 0 times | 0 times | 0 times | 0 times | 2 times | 4 times |
| | 0% | 0 times | 0 times | 0 times | 0 times | 0 times | 0 times |

In the Embodiment 1, the number of times of the switching of the potential difference during preliminary operation is set to twenty times so that it becomes possible to sufficiently suppress the uneven density due to the peeling-off defect throughout an entire period from a start of use of the development device 4 (process cartridge 8) until an end of life thereof. However, as it can be seen from Table 3, in cases in which the toner amount is small, for example, the switching of the potential difference is performed the number of times more than necessary. For example, in a case in which the remaining amount of the toner TJ is 40% and the toner deterioration lifetime is 60%, it is sufficient for the number of times of the switching of the potential difference to be four times, however, the switching is performed twenty times in the Embodiment 1. Upon increasing the number of times of the switching of the potential difference during preliminary operation, since a downtime until the image formation is started becomes lengthened by that amount, usability may be degraded.

Therefore, in the present Embodiment, the control portion 200 reads out, upon the start instruction of the job being input, the toner amount T and the accumulated deterioration degree of the toner Hr, which are stored in the memory 80, and calculates the remaining amount of the toner TJ and the toner deterioration lifetime GJ. The control portion 200 calculates the remaining amount of the toner TJ with the toner amount calculating portion 221 and calculates the toner deterioration lifetime GJ with the toner deterioration degree calculating portion 223. And the control portion 200 determines, according to the remaining amount of the toner TJ and the toner deterioration lifetime GJ, which are calculated, by referring to information indicating the relationship among the remaining amount of the toner TJ, the toner deterioration lifetime GJ and the number of times of the switching of the potential difference, the number of times of the switching of the potential difference during preliminary operation. In the present Embodiment, information indicating the relationship among the remaining amount of the toner TJ, the toner deterioration lifetime GJ, and the number of times of the switching of the potential difference, as shown in Table 4, is set in advance and stored as a table in the ROM 203. Incidentally, a case in which the number of times of the switching is zero corresponds to not performing the preliminary operation. As such, in the present Embodiment, the control portion 200 can control, according to the usage history information of the developing device 4 (the toner amount in the developing device 4 and the deterioration degree of the toner in the developing device 4), to switch between performing and not performing of the preliminary operation.

TABLE 4

| | | Toner deterioration lifetime GJ | | | | | |
|---|---|---|---|---|---|---|---|
| | | | | | | | More than |
| | | 0% | 1-20% | 21%-40% | 41%-60% | 61%-80% | 80% |
| Remaining | 100% | 10 times | 12 times | 14 times | 16 times | 18 times | 20 times |
| amount | 99%-80% | 6 times | 8 times | 10 times | 12 times | 14 times | 16 times |
| of toner | 79%-60% | 2 times | 4 times | 6 times | 8 times | 10 times | 12 times |
| | 59%-40% | 0 times | 0 times | 2 times | 4 times | 6 times | 8 times |
| | 39%-20% | 0 times | 0 times | 0 times | 0 times | 2 times | 4 times |
| | 20% or less | 0 times | 0 times | 0 times | 0 times | 0 times | 0 times |

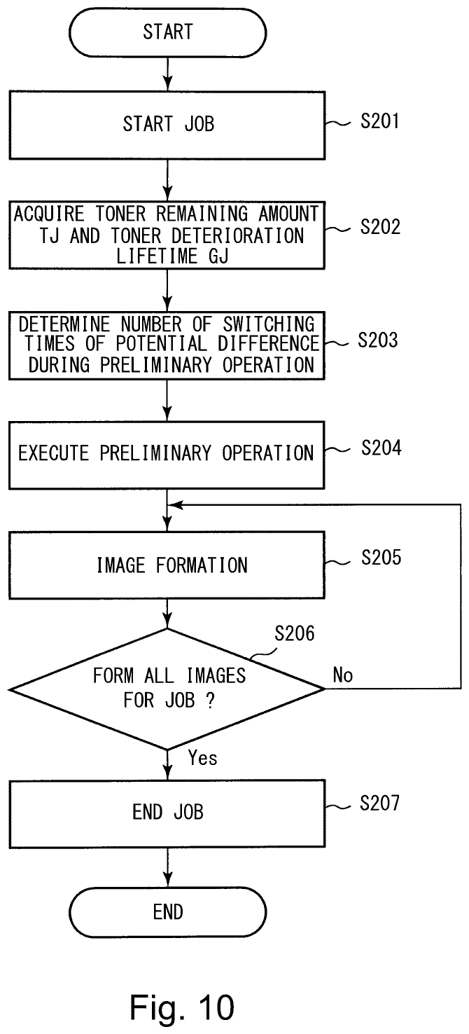

FIG. 10 is a flowchart diagram illustrating an outline of procedures of the job in the present Embodiment including the determination process for the number of times of the switching of the potential difference during preliminary operation described above. Upon the start instruction of the job being input, the control portion 200 starts the operation of the job (S201), acquires the remaining amount of the toner TJ and the toner deterioration lifetime GJ (S202), and determines the number of times of the switching of the potential difference during preliminary operation from the table shown in Table 4 (S203). And the control portion 200 controls to perform the preliminary operation to switch the potential difference between the developing roller 42 and the supplying roller 43 for the determined number of times (S204). Thereafter, the control portion 200 performs the image formation (S205), and determines whether or not all of the image formation in the job have been completed (S206). And if the control portion 200 determines in S206 that all of the image formation in the job has been completed, then controls to terminate the operation of the job (S207). On the other hand, if the control portion 200 determines in S206 that all of the image formation in the job has not been completed, then controls to return the process to S205 and perform the image formation.

### Effect of the Present Embodiment

Effect of the present Embodiment will be described. Here, among the present Embodiment, the aforementioned Embodiment 1-1, in which the number of times of the switching of the potential difference during preliminary operation is set constant at twenty times, and a Comparative Example 2, in which the number of times of the switching of the potential difference during preliminary operation is set constant at four times, the occurrence of the uneven density due to the peeling-off defect and a time required for the preliminary operation are compared. Results are shown in Table 5.

As a Case 1, a case in which the remaining amount of the toner TJ is 100% and the toner deterioration lifetime GJ is 80% is assumed. In the present Embodiment, since the number of times of the switching of the potential difference during preliminary operation is eighteen times, the time of 18 seconds are required before the image formation, and it is possible to suppress the occurrence of the uneven density due to the peeling-off defect. In the Embodiment 1-1, since the number of times of the switching of the potential difference during preliminary operation is twenty times, the time of 20 seconds are required before the image formation, and it is possible to suppress the occurrence of the uneven density due to the peeling-off defect. On the other hand, in the Comparative Example 2, since the number of times of the switching of the potential difference during preliminary operation is four times, the time required before the image formation is 4 seconds, however, the uneven density due to the peeling-off defect occurred in some cases.

As a Case 2, a case in which the remaining amount of the toner TJ is 40% and the toner deterioration lifetime GJ is 60% is assumed. In the present Embodiment, since the number of times of the switching of the potential difference during preliminary operation is four times, the time of 4 seconds are required before the image formation, and it is possible to suppress the occurrence of the uneven density due to the peeling-off defect. In the Embodiment 1-1, since the number of times of the switching of the potential difference during preliminary operation is twenty times, it is possible to suppress the occurrence of the uneven density due to the peeling-off defect, however, the time of 20 seconds are required before the image formation. In the Comparative Example 2, since the number of times of the switching of the potential difference during preliminary operation is four times, the time of 4 seconds are required before the image formation, and it is possible to suppress the occurrence of the uneven density due to the peeling-off defect.

TABLE 5

| | | Case 1 | Case 2 |
|---|---|---|---|
| | | Remaining | Remaining |
| | | amount of | amount of |
| | | toner 100% | toner 40% |
| | | Toner | Toner |
| | | deterioration | deterioration |
| | | lifetime 80% | lifetime 60% |
| Embodiment | Uneven density | Not occur | Not occur |
| 2 | Time before | 18 seconds | 4 seconds |
| | image formation | | |
| Embodiment | Uneven density | Not occur | Not occur |
| 1-1 | Time before | 20 seconds | 20 seconds |
| | image formation | | |
| Comparative | Uneven density | Occur | Not occur |
| Example 2 | Time before | 4 seconds | 4 seconds |
| | image formation | | |

According to the present Embodiment, in both of the Case 1 and the Case 2, it is possible to sufficiently suppress the occurrence of the uneven density due to the peeling-off defect, and shorten the downtime, which occurs before the image formation, corresponding to the remaining amount of the toner TJ and the toner deterioration lifetime GJ.

As described above, in the present Embodiment, the control portion 200 controls, based on the toner amount information regarding the toner amount in the developing device, to change the number of times for which the potential difference between the developing member 42 and the supplying member 43 are alternately switched to the first potential difference and to the second potential difference during preliminary operation. In the present Embodiment, when the toner amount indicated by the toner amount information is a first toner amount and a second toner amount lager than the first toner amount, the control portion 200 controls so that the number of times is larger in a case of the second toner amount than in a case of the first toner amount. In addition, in the present Embodiment, the control portion 200 controls, based on the deterioration degree information regarding the deterioration degree of the toner in the developing device 4, to change the number of times for which the potential difference is alternately switched to the first potential difference and to the second potential difference during preliminary operation. In the present Embodiment, when the deterioration degree indicated by the deterioration degree information is a first deterioration degree and a second deterioration degree further progressed than the first deterioration degree, the control portion 200 controls so that the number of times is larger in a case of the second deterioration degree than in a case of the first deterioration degree. In the present Embodiment, the control portion 200 acquires the deterioration degree information based on the information regarding the rotation time of developing member 42 and the toner amount information regarding the amount of the toner in the developing device 4. In addition, in particular, in the present Embodiment, the control portion 200 controls, based on the toner amount information regarding the toner amount in the developing device 4 and the deterioration degree information regarding the deterioration degree of the toner in the developing device 4, to change the number of times, for which the potential difference is alternately switched to the first potential difference and the second potential difference during preliminary operation.

As such, in the present Embodiment, the number of times of the switching of the potential difference between the developing roller 42 and the supplying roller 43 during preliminary operation is changed corresponding to the toner amount in the developing device 4 and the deterioration degree of the toner in the developing device 4. By this, it becomes possible to suppress the occurrence of the uneven density due to the peeling-off defect, and shorten the downtime which occurs prior to the image formation, thereby improving usability.

Incidentally, in the present Embodiment, the number of times of the switching of the potential difference between the supply roller 43 and the developing roller 42 during preliminary operation is changed corresponding to the toner amount in the developing device 4 and the deterioration degree of the toner in the developing device 4 as the usage history information, however, it is not limited thereto. For example, as the usage history information of the developing device 4, at least one of the toner amount in the developing device 4 and the deterioration degree of the toner in the developing device 4 may be used. In addition, for example, as the usage history information of the developing device 4, any index value correlated with a usage amount of the developing device 4 such as the drive time and a drive amount of the developing device 4 (such as the rotation time and a number of rotations of the developing roller 42, the supplying roller 43 and the stirring member 47), may be used.

Next, another Embodiment (Embodiment 3) of the present invention will be described. Basic configurations and operations of an image forming apparatus in the present Embodiment are the same as those in the Embodiment 1. Therefore, in the image forming apparatus in the present Embodiment, to those elements having functions or configurations that are the same as or corresponding to the image forming apparatus in the Embodiment 1, the same reference numerals as in the Embodiment 1 will be attached, and detailed description thereof will be omitted.

### Outline of the Present Embodiment

In the present Embodiment, unlike the Embodiments 1 and 2, the image forming apparatus 100 is configured so as to be capable of removing the toner accommodating chamber 46, which constitutes the developing device 4, from the developing chamber 45, which constitutes the developing device 4, to exchange. In the present Embodiment, the image forming apparatus 100 is configured so that the process cartridge 8 in the Embodiments 1 and 2 is substantially mountable to and dismountable from the apparatus main assembly 110, except that the toner accommodating chamber 46 is mountable to and dismountable from the developing chamber 45. Here, the toner accommodating chamber 46, which is mountable to and dismountable from the developing device 4 (process cartridge 8), is referred to as a toner cartridge 8T, and a part which is the process cartridge 8 minus the toner cartridge 8T is referred to as a process cartridge main assembly 8P.

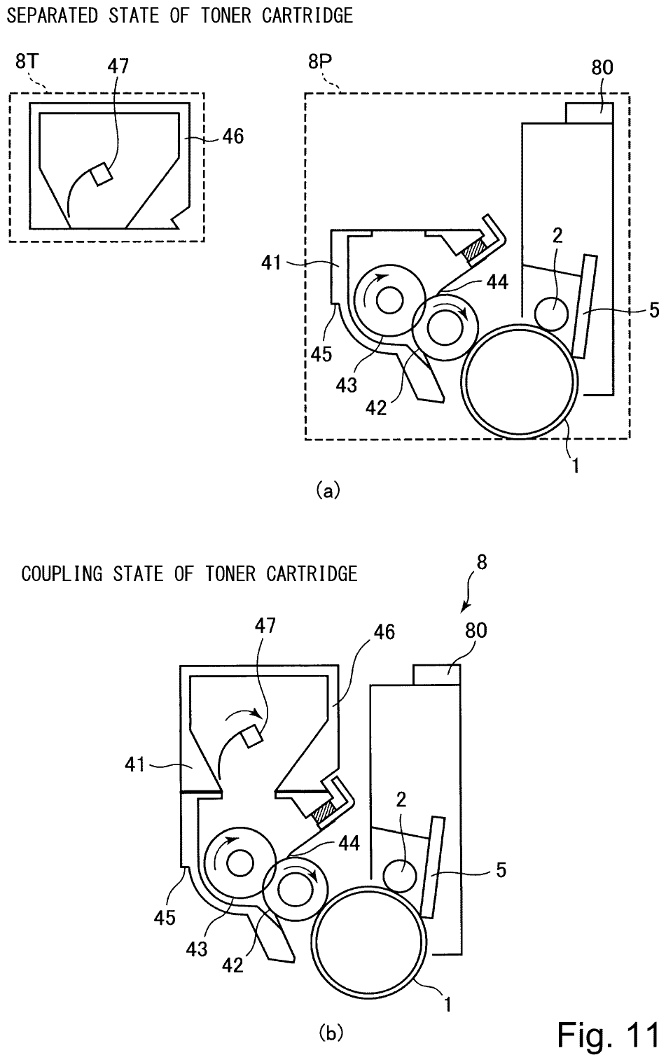

FIG. 11, part (a) and part (b), includes cross-sectional outline views illustrating a configuration of the process cartridge 8 in the present Embodiment. Part (a) of FIG. 11 illustrates a state in which the process cartridge main assembly 8P and the toner cartridge 8T are separated, and part (b) of FIG. 11 illustrates a state in which the process cartridge main assembly 8P and the toner cartridge 8T are connected. In the present Embodiment, the process cartridge 8 is configured so that the toner cartridge 8T can be separated, and upon the toner in the toner accommodating chamber 46 running out, by exchanging only the toner cartridge 8T of the process cartridge 8, the image formation becomes possible again. The toner cartridge 8T is constituted by the toner accommodating chamber 46, in which the toner is accommodated and which is provided with the stirring member 47. In addition, the developing chamber 45, which is provided with the developing roller 42, the supplying roller 43 and the regulating blade 44, is included in the process cartridge main assembly 8P.

A detection method for the toner amount T and a calculation method for the remaining amount of the toner TJ (a first toner amount information) in the present Embodiment are the same as in the Embodiment 2. In a case of the remaining amount of the toner TJ=0%, there is no toner in the toner cartridge 8T (toner accommodating chamber 46), and it is a state in which the toner amount TL upon the toner out remains in the developing chamber 45. A toner amount TF accommodated in a new toner cartridge 8T is TF=TM−TL. TM is the toner amount accommodated in the toner accommodating chamber 46 of the new process cartridge 8 (developing device 4). In other words, when the new toner cartridge 8T is mounted to the process cartridge main assembly 8P (when the toner cartridge 8T is exchanged), the toner amount in the developing device 4 becomes TM. In the present Embodiment, it is set that TL=30 g, TF=150 g, and TM=180 g.

<Calculation of the Deterioration Degree of the Toner after Exchange of the Toner Cartridge>

In a configuration in which the toner cartridge 8T is exchanged in a state in which the toner is left in the process cartridge 8, not all of the toner in the developing device 4 after exchange of the toner cartridge 8T is new toner, but it is in a state in which deteriorated toner and new toner are mixed. Therefore, after exchanging to the new toner cartridge 8T, the remaining amount of the toner returns to 100%, but the deterioration degree of the toner does not return to 0%. In the present Embodiment, this is taken into account to calculate the deterioration degree of the toner in the toner cartridge 8T after exchange.

A calculation method for the deterioration degree of the toner after exchange of the toner cartridge 8T in the present Embodiment will be described. Upon the toner cartridge 8T being exchanged, the control portion 200 calculates a total accumulated added deterioration degree of the toner Ht from the accumulated deterioration degree of the toner Hr since a start of usage of the process cartridge 8, the toner amount TL upon the toner out (a second toner amount information), and the toner amount TF of the new toner cartridge 8T, which are stored in the memory 80. Specifically, the total accumulated added deterioration degree of the toner Ht is obtained through the following equation (6). The control portion 200 calculates the total accumulated added deterioration degree of the toner Ht with the toner deterioration degree calculating portion 223.

$$Ht = Hr \times TL / ( TL + TF ) \qquad ( 6 )$$

In addition, the toner deterioration degree calculating portion 223 calculates the toner deterioration lifetime GJ based on the toner deterioration degree threshold value Wth, which is stored in the memory 80, and the total accumulated added deterioration degree of the toner Ht. Specifically, the toner deterioration lifetime GJ is obtained through the following equation (7).

$$GJ [ \% ] = Ht / Wth \times 100 \qquad ( 7 )$$

And the toner deterioration degree calculating portion 223 writes the total accumulated added deterioration degree of the toner Ht as the accumulated deterioration degree of the toner Hr into the memory 80.

A specific calculation example will be described. For example, assuming a case in which the toner cartridge 8T is exchanged in a state in which the toner deterioration lifetime GJ is 60% when the remaining amount of the toner TJ reaches 0%. When the toner deterioration lifetime GJ is 60%, the accumulated deterioration degree of the toner Hr is 0.6 Wth. When the toner cartridge 8T is exchanged in this state, the total accumulated added deterioration degree of the toner Ht is calculated as follows.

$$Ht = 0.6 Wth \times 30 / ( 30 + 150 ) = 0.1 Wth$$

From the total accumulated added deterioration degree of the toner Ht calculated here, the toner deterioration lifetime GJ is calculated as follows.

$$GJ [ \% ] = 0.1 Wth / Wth \times 100 = 10 \% .$$

Thus, in this case, after the toner cartridge 8T is exchanged, the remaining amount of the toner TJ becomes 100%, but the toner deterioration lifetime GJ becomes 10% and does not return to a state of a new product. As such, according to the calculation method for the deterioration degree of the toner in the present Embodiment, it becomes possible to obtain the toner deterioration lifetime GJ, which reflects the deterioration state of the toner in the state in which the deteriorated toner and the new toner are mixed.

### <Control for the Preliminary Operation>

Control for the preliminary operation before the image formation in the present Embodiment is the same as in the Embodiment 2.

### Effect of the Present Embodiment

As described above, in the present Embodiment, the developing device 4 includes the developing chamber 45 provided with the developing member 42 and the supplying member 43, and the toner accommodating chamber 46 in which the toner supplied to the developing chamber 45 is accommodated, and the toner cartridge 8T provided with the toner accommodating chamber 46 is mountable to and dismountable from the developing container 41 provided with the developing chamber 45, and in a case in which the toner cartridge 8T has been exchanged, the control portion 200 acquires, based on the first toner amount information regarding the amount of the toner in the developing device 4 before exchange, the second toner amount information regarding the amount of the toner in the developing device 4 after exchange, and a first deterioration degree information regarding the deterioration degree of the toner in the developing device 4 before exchange, a second deterioration degree information regarding the deterioration degree of the toner in the developing device 4 after exchange, and controls to change the number of times for which the potential difference between the developing member 42 and the supplying member 43 is alternately switched to the first potential difference and the second potential difference during preliminary operation based on the second toner amount information and the second deterioration degree information.

According to the present Embodiment, with the configuration in which the toner cartridge 8T of the process cartridge 8 is exchangeable, the same effect as in the Embodiment 2 can be obtained.

Incidentally, in the present Embodiment, it is configured that the toner accommodating chamber 46 is exchangeable as the toner cartridge 8T, however, it is not limited thereto. For example, it may be configured as a supply opening portion, which is an openable and closable opening portion, is provided to the toner accommodating chamber 46, so that new toner can be supplied to the toner accommodating chamber 46 through that supply opening portion. As such, in the developing device 4, the toner accommodating chamber 46 may also be configured to be supplied with the toner, and in this case, in a case in which the toner accommodating chamber is supplied with the toner, the control portion 200 acquires, based on a first toner amount information regarding the amount of the toner in the developing device 4 before supply, a second toner amount information regarding the amount of the toner in the developing device 4 after supply, and a first deterioration degree information regarding the deterioration degree of the toner in the developing device 4 before supply, a second deterioration degree information regarding the deterioration degree of the toner in the developing device 4 after supply, and controls to change the number of times, at which the potential difference is alternately switched to the first potential difference and the second potential difference during preliminary operation based on the second toner amount information and the second deterioration degree information.

Next, another Embodiment (Embodiment 4) of the present invention will be described. Basic configurations and operations of an image forming apparatus in the present Embodiment are the same as those in the Embodiment 1. Therefore, in the image forming apparatus in the present Embodiment, to those elements having functions or configurations that are the same as or corresponding to the image forming apparatus in the Embodiment 1, the same reference numerals as in the Embodiment 1 will be attached, and detailed description thereof will be omitted.

### Outline of the Present Embodiment

In the present Embodiment, as in the Embodiment 3, the image forming apparatus 100 is configured so that the toner cartridge 8T can be exchanged with respect to the developing device 4 (process cartridge 8). In the Embodiment 3, the deterioration degree of the toner after exchange of the toner cartridge 8T is calculated using the deterioration degree of the toner remaining in the developing device 4. In this calculation method, it is assumed that a case in which the deteriorated toner remaining in the developing device 4 and the new toner in the toner cartridge 8T are sufficiently mixed. However, it is found that in a case in which the toner amount in the toner cartridge 8T is large, the deteriorated toner and the new toner do not mix immediately in some cases. In those cases, for example, in the image formation immediately after the toner cartridge 8T is exchanged, due to a discrepancy between the calculation result of the toner deterioration lifetime GJ in the Embodiment 3 and an actual deterioration degree of the toner in the developing device 4, the uneven density due to the peeling-off defect may occur.

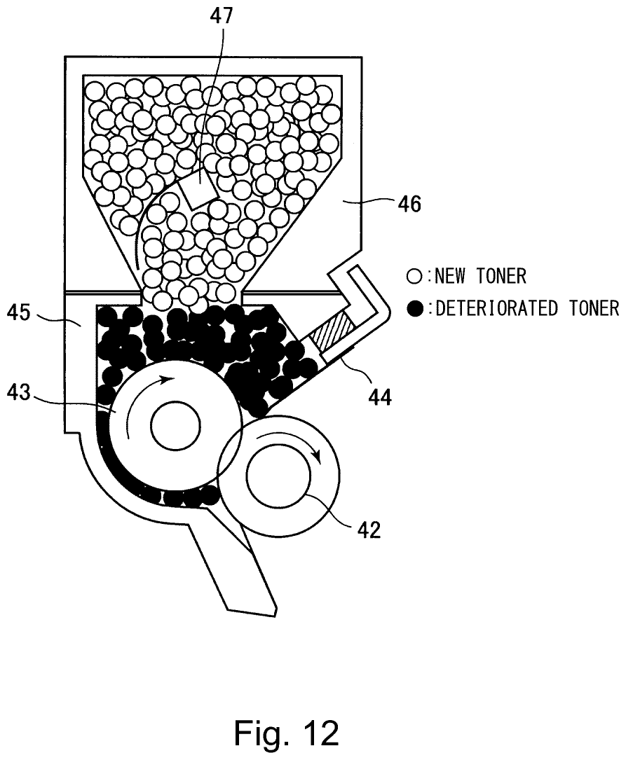

For example, assuming the case in which the toner cartridge 8T is exchanged in the state where the toner deterioration lifetime is 60% when the remaining amount of the toner TJ reaches 0%. In the Embodiment 3, since the toner amount TL upon the toner out is 30 g and the toner amount of the new toner cartridge TF is 150 g, the toner deterioration lifetime GJ is calculated as 10%. However, a state of the toner in the developing device 4 immediately after exchange of the toner cartridge 8T becomes, as shown in FIG. 12, a state in which the deteriorated toner is staying in the developing chamber 45 and the new toner is staying in the toner accommodating chamber 46. In such a state, since the toner in the vicinity of the V zone is the deteriorated toner, and a weight of the new toner is applied thereon, it becomes the same state as 180 g of the toner, of which the toner deterioration lifetime GJ is 60%, is present in the developing device 4. In this case, in the Embodiment 3, since the toner deterioration lifetime GJ is 10% and the remaining amount of the toner is 100%, the number of times of the switch of the potential difference during preliminary operation becomes twelve times (Table 4), however, this cannot loosen the toner in the vicinity of the V zone sufficiently, and the uneven density due to the peeling-off defect may occur. In order to sufficiently suppress the uneven density due to the peeling-off defect, actually, sixteen times of the switch of the potential difference during preliminary operation are required (Table 4).

The problem as described above can be solved, after exchange of the toner cartridge 8T, by rotating the stirring member 47 for a sufficiently long time and sufficiently mixing the deteriorated toner in the developing chamber 45 and the new toner in the toner cartridge 8T. However, while the stirring member 47 is being rotated for the long period of time, the image formation cannot be performed, which may result in degradation of usability.

Therefore, in the present Embodiment, it is aimed that, after exchange of the toner cartridge 8T, in the state in which the deteriorated toner in the developing chamber 45 and the new toner in the toner cartridge 8T are not mixed, the number of times of the switch of the potential difference during preliminary operation can be set appropriately.

<Calculation of the Deterioration Degree of the Toner after Exchange of the Toner Cartridge>

A calculation method for the deterioration degree of the toner after exchange of the toner cartridge 8T in the present Embodiment will be described. Upon the toner cartridge 8T being exchanged, the control portion 200 calculates the total accumulated added deterioration degree of the toner Ht from the accumulated deterioration degree of the toner Hr since the start of usage of the process cartridge 8, the toner amount TL upon the toner out, and the toner amount TF of the new toner cartridge, which are stored in the memory 80. Specifically, the total accumulated added deterioration degree of the toner Ht is obtained through the following equation (8). The control portion 200 calculates the total accumulated added deterioration degree of the toner Ht with the toner deterioration degree calculating portion 223.

$$Ht = Hr \times TL / ( TL + TF ) \qquad ( 8 )$$

In addition, the toner deterioration degree calculating portion 223 calculates a first toner deterioration lifetime GJ1 (first deterioration degree information) from the toner deterioration threshold value Wth stored in the memory 80 and the total accumulated added deterioration degree of the toner Ht. Specifically, the first toner deterioration lifetime GJ1 is obtained through the following equation (9).

$$GJ 1 [ \% ] = Ht / Wth \times 100 \qquad ( 9 )$$

Next, the toner deterioration degree calculating portion 223 calculates a second toner deterioration lifetime GJ2 (second deterioration degree information). Specifically, the second toner deterioration lifetime GJ2 is obtained through the following equation (10). Where Hr in the equation (10) is the accumulated deterioration degree of the toner Hr which is stored in the memory 80 at the latest before exchange of the toner cartridge 8T.

$$GJ 2 [ \% ] = Hr / Wth \times 100 \qquad ( 10 )$$

And the toner deterioration degree calculating portion 223 writes the total accumulated added deterioration degree of the toner Ht as the accumulated deterioration degree of the toner Hr into the memory 80. In addition, in the present Embodiment, the toner deterioration degree calculating portion 223 stores the calculated second toner deterioration lifetime GJ2 into the memory 80. However, it may be configured as the accumulated deterioration degree of the toner Hr, which is stored in the memory 80 at the latest before exchange of the toner cartridge 8T, is stored in the memory 80 so that the second toner deterioration lifetime GJ2 can be calculated as appropriate.

Here, the first toner deterioration lifetime GJ1 is the same as the toner deterioration lifetime GJ calculated in the Embodiment 3, and is the toner deterioration lifetime when the degraded toner in the developing chamber 45 and the new toner in the toner cartridge 8T are sufficiently mixed is calculated. On the other hand, the second toner deterioration lifetime GJ2 is the toner deterioration lifetime when the deteriorated toner in the developing chamber 45 and the new toner in the toner cartridge 8T are not mixed is calculated.

### <Control for the Preliminary Operation>

In the present Embodiment, upon the start instruction of the job being input, the control portion 200 reads the toner amount T and the accumulated deterioration degree of the toner Hr stored in the memory 80, and calculates the remaining amount of the toner TJ and the toner deterioration lifetime GJ (the first toner deterioration lifetime GJ1 and the second toner deterioration lifetime GJ2). And the control portion 200, according to the calculated remaining amount of the toner TJ and the toner deterioration lifetime GJ (the first toner deterioration lifetime GJ1 and the second toner deterioration lifetime GJ2), refers to the information indicating the relationship among the toner amount TJ, the toner deterioration lifetime GJ and the number of times of the switching of the potential difference, and determines the number of times of the switching of the potential difference during preliminary operation. In the present Embodiment, the table referred to at this time is configured to be the same table as shown in Table 4, which is described in the Embodiment 2. This table is set in advance and stored in the ROM 203.

Here, the control portion 200 performs a determination, as follows, as the toner deterioration lifetime GJ, as to which of the first toner deterioration lifetime GJ1 and the second toner deterioration lifetime GJ2 is to be used. In the present Embodiment, the control portion 200 stores a moved distance of the surface Wt after exchange, which is an integrated value of the moved distance of the surface Wu of developing roller 42 since the exchange of the toner cartridge 8T, in the memory 80. Specifically, the distance calculating portion 222 of the control portion 200 integrates the moved distance of the surface Wt after exchange and stores it in the memory 80. And if the moved distance of the surface Wt after exchanged is greater than a threshold value Wth2, which is set in advance and stored in the memory 80, then the control portion 200 refers to the table in Table 4 as GJ=GJ1, and determines the number of times of the switching of the potential difference during preliminary operation. On the other hand, if the moved distance of the surface Wt after exchange is less than the threshold value Wth2, then the control portion 200 refers to the table in Table 4 as GJ=GJ2, and determines the number of times of the switching of the potential difference during preliminary operation. By this, if the moved distance of the surface Wt after exchange is the threshold value Wth2 or more, then it becomes possible to determine the number of times of the switching with the assumption that the deteriorated toner in the developing chamber 45 and the new toner in toner cartridge 8T are sufficiently mixed. In addition, if the moved distance of the surface Wt after exchange is less than the threshold value Wth2, then it becomes possible to determine the number of times of the switching with the assumption that the deteriorated toner in the developing chamber 45 and the new toner in the toner cartridge 8T are not mixed. In the present Embodiment, it is set as Wth2=10920 mm. This is the moved distance of the surface of the developing roller 42 when the developing roller 42 is rotated for sixty seconds. The threshold value Wth2 is a value determined through an experiment in which a time required for the deteriorated toner in the developing chamber 45 and the new toner in the toner cartridge 8T to be mixed sufficiently is measured. Therefore, it is not limited to this value, but can be set as appropriate according to the configuration of the developing device 4.

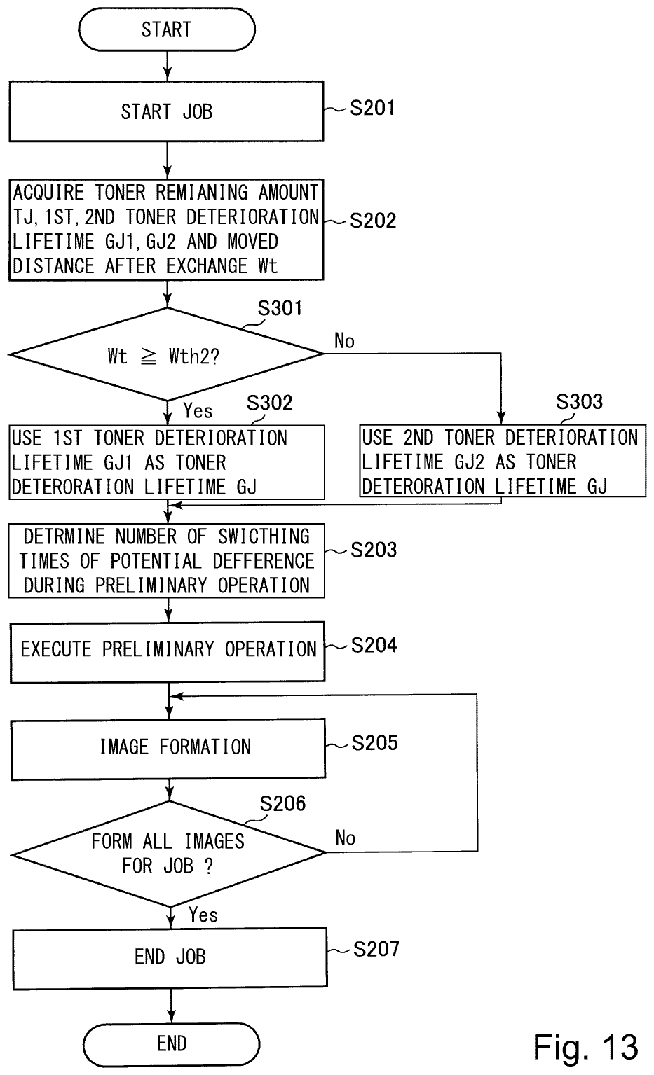

FIG. 13 is a flowchart diagram illustrating an outline of procedures of the job in the present Embodiment including the determination process for the number of times of the switching of the potential difference during preliminary operation described above. In the procedures in FIG. 13, to a procedure which is the same procedure as in the Embodiment 2 shown in FIG. 10, the same step number is attached as in FIG. 10, and description thereof will be omitted as appropriate. In the present Embodiment, the control portion 200 acquires, in S202, the remaining amount of the toner TJ, the first toner deterioration lifetime GJ1, the second toner deterioration lifetime GJ2, and the moved distance of the surface Wt after exchange. And in the present Embodiment, the control portion 200 determines whether or not the moved distance of the surface Wt after exchange is the threshold value Wth2 or more (S301). And if the control portion 200 determines in S301 that Wt is Wth2 or more (Wt≥Wth2), then determines to use the first toner deterioration lifetime GJ1 as the toner deterioration lifetime GJ (S302). On the other hand, if the control portion 200 determines that Wt is less than Wth2 (Wt<Wth2) in S302, then determines to use the second toner deterioration lifetime GJ2 as the toner deterioration lifetime GJ (S303). In addition, in the present Embodiment, the control portion 200 determines, in S203, the number of times of the switching of the potential difference during preliminary operation from the table shown in Table 4 based on the remaining amount of the toner TJ and the toner deterioration lifetime GJ, which is determined in S302 or S303. In the present Embodiment, the first toner deterioration lifetime GJ1 and the second toner deterioration lifetime GJ2 are acquired, and whether or not the moved distance of the surface Wt after exchanged is the threshold value Wth2 or more is determined, however, it is not limited thereto. For example, it may be configured as after determining whether or not the moved distance of the surface Wt after exchange is the threshold value Wth2 or more, the required toner deterioration lifetime is acquired.

### Effect of the Present Embodiment

Effect of the present Embodiment will be described. Here, with respect to the case in which the toner cartridge 8T is exchanged in the state where the toner deterioration lifetime is 60% when the remaining amount of the toner TJ reaches 0%, a comparison between the present Embodiment and the Embodiment 3 is made. Print of a halftone image of 25% density is performed after exchange of the toner cartridge 8T with each configuration, and presence or absence of the occurrence of the uneven density due to the peeling-off defect is checked. Results are shown in Table 6.

TABLE 6

| | | Number of times | Uneven |
|---|---|---|---|
| | Print Timing | of switching | density |
| Embodiment 4 | Immediately after | 16 times | Not occur |
| | exchange of toner | | |
| | cartridge | | |
| | After sixty seconds | 12 times | Not occur |
| | drive after exchange | | |
| | of toner cartridge | | |
| Embodiment 3 | Immediately after | 12 times | Occur |
| | exchange of toner | | |
| | cartridge | | |
| | After sixty seconds | 12 times | Not occur |
| | drive after exchange | | |
| | of toner cartridge | | |

In the configuration of the present Embodiment, at a time of the image formation immediately after exchange of the toner cartridge 8T, the deteriorated toner in the developing chamber 45 and the new toner in the toner cartridge 8T are not sufficiently mixed. However, since the number of times of the switching of the potential difference during preliminary operation is sixteen times, the uneven density due to the peeling-off defect did not occur. Thereafter, when the image formation is performed after the developing device 4 is driven for sixty seconds, the number of times of the switching of the potential difference during preliminary operation becomes twelve times. However, since the deteriorated toner in the developing chamber 45 and the new toner in the toner cartridge 8T are sufficiently mixed, the uneven density due to the peeling-off defect did not occur.

In addition, in the configuration of the Embodiment 3, as in the present Embodiment, at the time of the image formation immediately after exchange of the toner cartridge 8T, the deteriorated toner in the developing chamber 45 and the new toner in the toner cartridge 8T are not sufficiently mixed. And in the Embodiment 3, since the number of times of the switching of the potential difference during preliminary operation is twelve times, the uneven density due to the peeling-off defect occurred in some cases. For example, such cases include a case of a low-temperature and low-humidity environment in which the toner is likely to be packed. Thereafter, when the image formation is performed after the developing device 4 is driven for sixty seconds, the number of times of the switching of the potential difference during preliminary operation is still twelve times, however, since the deteriorated toner in the developing chamber 45 and the new toner in the toner cartridge 8T are sufficiently mixed, the uneven density due to the peeling-off defect did not occur.

As described above, in the present Embodiment, the control portion 200 controls to change the number of times, for which the potential difference between the developing member 42 and the supplying member 43 are alternately switched to the first potential difference and the second potential difference during preliminary operation, based on the information regarding the rotation time of the developing member 42 after exchange of the toner cartridge T8. In the present Embodiment, when the rotation time indicated by the information regarding the rotation time of the developing member after exchange is a first rotation time and a second rotation time shorter than the first rotation time, the control portion 200 controls so that the number of times is larger in a case in which the rotation time is the second rotation time than in a case in which the rotation time is the first rotation time. Incidentally, in the configuration in which the toner accommodating chamber 46 can be supplied with the toner, the control portion 200 can control to change the number of times, for which the potential difference is alternately switched to the first potential difference and the second potential difference during preliminary operation, based on the information regarding the rotation time of developing member 42 after supply. In this case, when the rotation time indicated by the information regarding the rotation time of the developing member after supply is a first rotation time and a second rotation time shorter than the first rotation time, the control portion 200 can control so that the number of times is larger in a case in which the rotation time is the second rotation time than in a case in which the rotation time is the first rotation time.

As such, according to the present Embodiment, even if the image formation is performed immediately after exchange of the toner cartridge 8T and in the state in which the deteriorated toner in the developing chamber 45 and the new toner in the toner cartridge 8T are not sufficiently mixed, it becomes possible to suppress the occurrence of the uneven density due to the peeling-off defect.

As described above, the present invention has been described according to the specific Embodiments, however, the present invention is not limited to the above Embodiments.

In the Embodiments described above, the developing device is configured as the developing chamber is disposed at the lower side in the direction of gravity with respect to the toner accommodating chamber. As described above, in the case of such the configuration, since the toner around the developing roller and the supplying roller is likely to be the compacted state when the remaining amount of the toner is large, etc., the effect of the present invention becomes particularly significant. However, it is not limited to thereto, but the present invention can be applied, for example, to a configuration in which the developing chamber is disposed side-by-side with respect to the toner accommodating chamber in a horizontal direction, etc. In a case of such the configuration, when the remaining amount of the toner is large, etc., due to the conveyance force by the stirring member, etc., the toner around the developing roller and the supplying roller is likely to be the compacted state in some cases. Therefore, the present invention is also effective in such the configuration.

In addition, the developing device is not necessarily be configured to be mountable to and dismountable from the main assembly of the image forming apparatus. In addition, it may be configured that the toner cartridge is mountable to and dismountable from the developing chamber which is fixed to and disposed at the main assembly of the image forming apparatus. In this case, it may be configured as the image formation is performed with the toner cartridge kept attached to the developing chamber, or as the image formation is performed after the toner cartridge is dismounted from the developing chamber after the toner is supplied to the developing chamber.

According to the present invention, it becomes possible to suppress the occurrence of the image defect due to the peeling-off of the toner from the developing member with the supplying member becoming insufficient.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-077636, filed May 12, 2024, which is hereby incorporated by reference herein in its entirety.

What is claimed is:

1. An image forming apparatus comprising:
a rotatable image bearing member;
a developing unit configured to develop an electrostatic latent image formed on a surface of the image bearing member with toner, the developing unit including a rotatable developing member configured to supply the toner to the electrostatic latent image and a rotatable supplying member in contact with the developing member and configured to supply the toner to the developing member;
a developing voltage applying portion configured to apply a voltage to the developing member;
a supplying voltage applying portion configured to apply a voltage to the supplying member; and
a control portion configured to control the developing voltage applying portion and the supplying voltage applying portion,
wherein during non-image formation in a state in which the developing member and the supplying member rotate, the control portion is capable of controlling the developing voltage applying portion and the supplying voltage applying portion so as to perform a preliminary operation in which a first potential difference and a second potential difference different from the first potential difference are formed between the developing member and the supplying member and alternately switched for a plurality of number of times based on toner amount information regarding a toner amount in the developing unit.

2. An image forming apparatus according to claim 1, wherein the control portion controls to perform the preliminary operation from input of a start instruction of a job, in which an image is formed on a single recording material or a plurality of recording materials and is output, until start of the development of the electrostatic laten image corresponding to a first image in the job.

3. An image forming apparatus according to claim 1, wherein the control portion controls so that a voltage to be applied to the supplying member becomes larger on a normal polarity side of the toner relative to a voltage to be applied to the developing member when at least one of the first potential difference and the second potential difference is formed.

4. An image forming apparatus according to claim 3, wherein the control portion controls so that a voltage to be applied to the supplying member and a voltage to be applied to the developing member become substantially the same when at least one of the first potential difference and the second potential difference is formed.

5. An image forming apparatus according to claim 1, wherein the developing unit includes a developing chamber provided with the developing member and the supplying member, and a toner accommodating chamber in which the toner supplied to the developing chamber is accommodated, and
wherein the developing chamber is disposed at a lower side of the toner accommodating chamber in a direction of gravity.

6. An image forming apparatus according to claim 2, wherein the control portion controls to perform the preliminary operation based on information regarding a time from stop of rotation of the developing member with termination of a previous job until start of rotation of the developing member with start of a current job.

7. An image forming apparatus according to claim 6, wherein when the time indicated by the information is a first time and a second time longer than the first time, the control portion controls so that the number of times becomes larger in a case in which the time is the second time than in a case in which the time is the first time.

8. An image forming apparatus according to claim 1, wherein the control portion controls a driving device which rotates at least one of the developing member and the supplying member so that a rotation speed of at least one of the developing member and the supplying member becomes faster during the preliminary operation than during image formation in which the development is performed.

9. An image forming apparatus according to claim 1, wherein when the toner amount indicated by the toner amount information is a first toner amount and a second toner amount lager than the first toner amount, the control portion controls so that the number of times becomes larger in a case of the second toner amount than in a case of the first toner amount.

10. An image forming apparatus according to claim 1, wherein the control portion controls to perform the preliminary operation based on deterioration degree information regarding a deterioration degree of the toner in the developing unit.

11. An image forming apparatus according to claim 10, wherein when the deterioration degree indicated by the deterioration degree information is a first deterioration degree and a second deterioration degree further progressed than the first deterioration degree, the control portion controls so that the number of times becomes larger in a case of the second deterioration degree than in a case of the first deterioration degree.

12. An image forming apparatus according to claim 10, wherein the control portion acquires the deterioration degree information based on information regarding a rotation time of the developing member and toner amount information regarding the amount of the toner in the developing unit.

13. An image forming apparatus according to claim 1, wherein the developing unit includes a developing chamber provided with the developing member and the supplying member, and a toner accommodating chamber in which the toner supplied to the developing chamber is accommodated,
wherein a toner cartridge provided with the toner accommodating chamber is mountable to and dismountable from a developing container provided with the developing chamber; and
wherein in a case in which the toner cartridge has been exchanged,
the control portion acquires, based on a first toner amount information regarding an amount of the toner in the developing unit before exchange, a second toner amount information regarding an amount of the toner in the developing unit after exchange, and a first deterioration degree information regarding a deterioration degree of the toner in the developing unit before exchange, a second deterioration degree information regarding a deterioration degree of the toner in the developing unit after exchange, and
controls to perform the preliminary operation based on the second toner amount information and the second deterioration degree information.

14. An image forming apparatus according to claim 13, wherein the control portion controls to perform the preliminary operation based on information regarding a rotation time of the developing member after exchange.

15. An image forming apparatus according to claim 14, wherein when the rotation time indicated by the information regarding the rotation time of the developing member after exchange is a first rotation time and a second rotation time shorter than the first rotation time, the control portion controls so that the number of times becomes larger in a case in which the rotation time is the second rotation time than in a case in which the rotation time is the first rotation time.

16. An image forming apparatus according to claim 1, wherein the developing unit includes a developing chamber provided with the developing member and the supplying member, and a toner accommodating chamber in which the toner supplied to the developing chamber is accommodated,
wherein the toner accommodating chamber is configured to be supplied with the toner, and
wherein in a case in which the toner accommodating chamber is supplied with the toner,
the control portion acquires, based on a first toner amount information regarding an amount of the toner in the developing unit before supply, a second toner amount information regarding an amount of the toner in the developing unit after supply, and a first deterioration degree information regarding a deterioration degree of the toner in the developing unit before supply, a second deterioration degree information regarding a deterioration degree of the toner in the developing unit after supply, and
controls to perform the preliminary operation based on the second toner amount information and the second deterioration degree information.

17. An image forming apparatus according to claim 16, wherein the control portion controls to perform the preliminary operation based on information regarding a rotation time of the developing member after supply.

18. An image forming apparatus according to claim 17, wherein when the rotation time indicated by the information regarding the rotation time of the developing member after supply is a first rotation time and a second rotation time shorter than the first rotation time, the control portion controls so that the number of times becomes larger in a case in which the rotation time is the second rotation time than in a case in which the rotation time is the first rotation time.
